(19) United States
(12) Patent Application Publication
(10) Pub. No.: US 2007/0194939 A1
(43) Pub. Date: Aug. 23, 2007

(54) HEALTHCARE FACILITIES OPERATION

(76) Inventors: Frank D. Alvarez, Tucson, AZ (US); Terri Dupperknoper, Tucson, AZ (US)

Correspondence Address: LEWIS AND ROCA LLP, 40 NORTH CENTRAL AVENUE, PHOENIX, AZ, 85004, US

(21) Appl. No.: 11/675,017

(22) Filed: Feb. 14, 2007

Related U.S. Application Data
(60) Provisional application No. 60/743,328, filed on Feb. 21, 2006.

(51) Int. Cl. G08B 23/00; G08B 5/22; H04N 7/18

(52) U.S. Cl. 340/573.1; 340/286.07; 348/143

(57) ABSTRACT

Healthcare facility nurse-patient ratios are minimized by providing patients with in-room devices to request and receive real time audio visual (AV) communications with advocates responsible for the patients' healthcare. Each device enables the patient to see and hear their assigned advocate, as well as to communicate to the advocate a category of the patient's present subjective pain level. While advocates assume communication and coordination responsibilities for non-medical services provided to their assigned patients, they also assume responsibilities on behalf of their assigned patient with nursing staff whose responsibilities will preferably exclude non-medical services but will rather be limited to medical services provided to the advocate's assigned patients. Advocate operated work stations can remotely adjust AV and vital site monitoring equipment in the hospital room, thereby enabling the selective seeing and hearing of real time events. Data from these events can be stored in the patient's electronic medical record.

### CROSS NOTING

The application claims priority to U.S. Provisional Application Ser. No. 60/743,328, filed on Feb. 21, 2006, titled “System and Method For Healthcare Facility Operation”, which is incorporated herein by reference.

### BACKGROUND TECHNICAL FIELD

The present invention relates generally to healthcare, and is more particularly related to systems and methods of operating healthcare facilities.

### BACKGROUND

Operation of a healthcare facility, such as a hospital, requires numerous workers skilled in providing healthcare. Optimization is needed in the workflow of healthcare workers in providing healthcare while accessing patient data necessary to treatment. An objective of such optimization is to provide a professionally competent level of healthcare to an increasing number of patients with a decreasing number of healthcare workers. Stated otherwise, an objective is to increase the ratio of patients to healthcare workers while maintaining, if not increasing, a professionally competent level of healthcare. A constraint on such optimization has been legacy patient information and communication methods and systems.

Legacy patient information and communication methods and systems cause a myriad of problems. These problems, some of which are illustrated in FIG. 1, are largely due to fragmented system and methods for scheduling and workflow management. By way of example, these problems include services that are to be provided to a patient yet are not being provided due to time conflicts in scheduling healthcare treatments and services. Miscommunication is another problem which further causes mistakes to happen. Duplication of work is a problem as are situations where a patient's family is uncertain as to the patient's status, causing the further problem of the patient's family feeling helpless due to a lack of ready information about the patient. A still further problem is that skilled healthcare workers are required to spend too much time outside of their particular area of expertise in doing work that does not require their area of expertise. For example, floor nurses often must try to help pharmacy, dietary and social service units instead of simply providing nursing services. Radiology may have a staff member who is coming to get a patient in the patient's room instead of a staff member of a patient transportation department doing the task, again due to poor scheduling and workflow management.

In the prior art model illustrated in FIG. 1, people in pharmacy, dietary, social service, radiology, surgery, patient care areas, lab and physicians offices having specialized tasks that they must accomplish while also interfacing together to share information, yet do so in a fragmented way. Nevertheless, some tasks to be done by one department end up being done by someone in a different department. It would be an advance in the art to provide patient information and communication methods and systems to provide a professionally competent level of healthcare to an increasing number of patients with a decreasing number of healthcare workers, where work is given to a worker based upon their area of expertise.

FIG. 39 graphically depicts a prior art floor staff organization in a healthcare facility. In this organizational system, a floor nurse has many responsibilities to many centers of control. As such, there is a need for improvement in the work efficiency of the floor nurse that would limit the responsibility of the floor nurse to tasks ordinarily performed by medically trained personnel. It would be an advance in the art to increase the ratio of the number of patients for which each floor nurse is directly responsible by reducing the non-medical tasks that are required to be performed by floor nurses.

FIG. 14 shows low skill tasks that are required to be performed by highly skilled healthcare workers in prior art healthcare facilities, including much data entry and documentation which takes the highly skilled healthcare workers away from the bedside and the patient, such as running errands and coordinating services, and keeping track of multiple responsibilities. Nursing in prior art facilities is not always focused on the patient due to the nurse's duty to keep track of multiple responsibilities, thereby mandating that the nurse be all things to everyone. It would be an advance in the art to transfer low skill tasks from highly skilled healthcare workers.

If a nurse is assigned 10 or 12 patients, in order to remember tasks, the nurse may write a hand written note as to those tasks that are to be accomplished for each patient, including the relatively priority of these tasks. It would be an advance in the art to automatically display tasks assigned to a nurse, which display would include the priority of each task relative to other assigned tasks.

### SUMMARY

In one implementation, technologies are disclosed for an in-patient hospital room having a hospital bed for a hospital patient. A remotely adjustable audio-visual (AV) apparatus captures real time motion for each of a plurality of views of the in-patient hospital room and also captures real time sound in the in-patient hospital room. An input and display device with related apparatus is provided to request and receive communications with a communicant outside of the in-patient hospital room. Optionally, a subjective hospital patient pain level category can be received and communicated to the communicant outside of the in-patient hospital room.

In another implementation, technologies are disclosed for a hospital patient monitoring work station for a plurality of in-patient hospital rooms in a hospital. The work station has an input and rendering device with related apparatus to selectively direct real time audio-visual (AV) media from a two-way communication with a communicant outside of a selected one of the in-patient hospital room to a communicant inside the selected in-patient hospital room. This communication can be requested by the hospital patient. As an optional part of this communication, the input and rendering device can adjust, receive, and render each of a plurality of views of the selected in-patient hospital room from a respective remotely adjustable AV apparatus that capture for the selected in-patient hospital room real time motion in each of the views as well as real time sound.

In a still further implementation, a system monitors patient well being in a plurality of hospitals each having a plurality of hospital rooms, where each hospital room has a hospital bed for a patient. In various implementations, the system provides for each hospital room, the ability to receive input from the patient requesting and receive a two-way audio visual communication a patient care advocate assigned to the patient. The system also include a plurality of a hospital patient monitoring work stations each being operated by one of the patient care advocates. Each patient care advocate is assigned to many patients. Each said work station has an input and rendering device with related apparatus through which the patient care advocate can selectively receive, from the patients assigned to the patient care advocate, the request for the two-way AV communication, and also can direct, in response to a selected request received from an assigned patient, the requested two-way AV communication from between the patient and the patient care advocate. The requested two-way AV communication from between the patient and the patient care advocate, when selected by the patient care advocate, can then be displayed at the work station. Each work station includes the ability to selectively initiate and terminate the two-way communication between the patient and the patient care advocate.

### BRIEF DESCRIPTION OF THE DRAWINGS

A more complete understanding of the implementations may be had by reference to the following detailed description when taken in conjunction with the accompanying drawings wherein:

FIG. 1 depicts problems associated with prior art healthcare facility operations;

FIG. 2 shows a system having a control center that provides an interface for each of the departments of pharmacy, dietary, social service, radiology, surgery, patient care areas, lab and physicians offices;

FIG. 3 shows two persons at work in the control center of FIG. 1, one of which is a Patient Care Advocate (PCA) and the other of which is a stenographer;

FIG. 4 indicates the functions performed by the Patient Care Advocate (PCA);

FIG. 5 shows the PCA of FIG. 4 observing a User Interface (UI) having left and right displays;

FIG. 6 shows the left display of the PCA's UI of FIG. 5;

FIG. 7 shows the right display of the PCA's UI of FIG. 5;

FIG. 8 shows PCA selectable customizing display options for the left display of the PCA's UI of FIG. 5, including a real time audio visual camera adjustment function for a selected hospital room;

FIGS. 9-12 shows respective selectable screens that can be viewed by the PCA via the PCA's UI;

FIG. 13 shows alerts from which workflow for a PCA is driven;

FIG. 14 depicts a prior art healthcare facility in which low skill tasks are required to be performed by highly skilled healthcare workers;

FIG. 15 shows several low skill tasks that will not be performed by highly skilled healthcare workers in implementations of an inventive healthcare facility;

FIG. 16 shows a scale against which each nurse is numerically and graphically assessed as to proficiency is each of several nursing tasks;

FIG. 17 shows the scheduling of tasks according to proficiency;

FIGS. 18-19 show respective screens that can be used by a nurse in an inventive healthcare facility;

FIG. 20 shows a display that indicates the integration with outside communicants via a control center in an inventive healthcare facility;

FIG. 21 show a patient experience in an inventive healthcare facility via a patient portal;

FIG. 22 shows the patient portal of FIG. 21;

FIG. 23 shows core technologies of an inventive healthcare facility, including a control center having a database system, an enterprise or integration backbone, and a plurality of wireless networking devices and user consoles;

FIG. 24 shows functional components which can be used in the control center seen in FIG. 23;

FIG. 25 illustrates an order entry providing for an entry of an order set from a physician for the sequence of events required to treat a patient with in-patient healthcare services;

FIG. 26 shows a block level diagram depicting an exemplary order set for a patient;

FIGS. 27-29 illustrate an exemplary method involving a control center, where a PCA accepts a patient to be admitted to a healthcare facility

FIG. 30 shows an exemplary method for a nurse to orally dictate a summary of a service provided to a patient or a diagnosis of a patient;

FIG. 31 shows the digital coding of an oral dictation such as is seen in FIG. 30;

FIG. 32 shows an environment in which a patient can call a assigned Patient Care Advocate using a touch screen display;

FIG. 33 shows a dialog box provided by a user interface for the PCA called as in FIG. 32 to control the volume heard from the patient's room as well as a button to terminate the audio-video recordation session with the patient, as well as a picture-in-a-picture depicting real time audio visual (AV) media of the PCA a communicant with the patient;

FIG. 34 is a view of a patient portal in which a patient sees and communicates with the PCA as a rendering of real time AV media;

FIG. 35 shows a typical prior art time line illustrating an inefficient process of discharging a patient from the hospital;

FIG. 36 shows an improvement of the prior art discharge process seen in FIG. 35 for implementations of the present invention in which the discharge order substantially starts at the time when a patient arrives;

FIG. 37 shows, for the time of discharge, a bill that can be drawn up for the services rendered to a patient;

FIG. 38 is a block level diagram showing a floor staff organization in which one (1) person oversees a limited number of discrete responsibilities, and also shows the function of a task worker in a floor staff organization;

FIGS. 39 and 40 graphically depict prior art and inventive floor staff organizations, respectively;

FIG. 41 provides an overview of personnel that are assigned to a control center of an in-patient a healthcare facility;

FIG. 42 shows categories of responsibilities assigned to the Patient Care Advocate, including general tasks, actions, monitoring, and contact responsibilities;

FIGS. 43-44 show, respectively, preferred PCA and Flight Controller medical qualifications;

FIG. 45 shows an exemplary implementation for organization of the Patient Care Advocate role and function;

FIG. 46 depicts four (4) different environments that might be suitable for respective implementations of an Enterprise Control Center operated by PCAs and Flight Controllers for the benefit of one or more healthcare facilities which are remote one from another;

FIG. 47 shows, for three (3) different healthcare facilities, an overall view, called an “Enterprise Control Center” view, is given of the relative capacity of each unit in a healthcare facility;

FIGS. 48-50 show different views that can be depicted for the Enterprise Control Center of FIG. 47; and

FIG. 51 is a diagrammatic depiction of an implementation of the inventive control center and communications therewith.

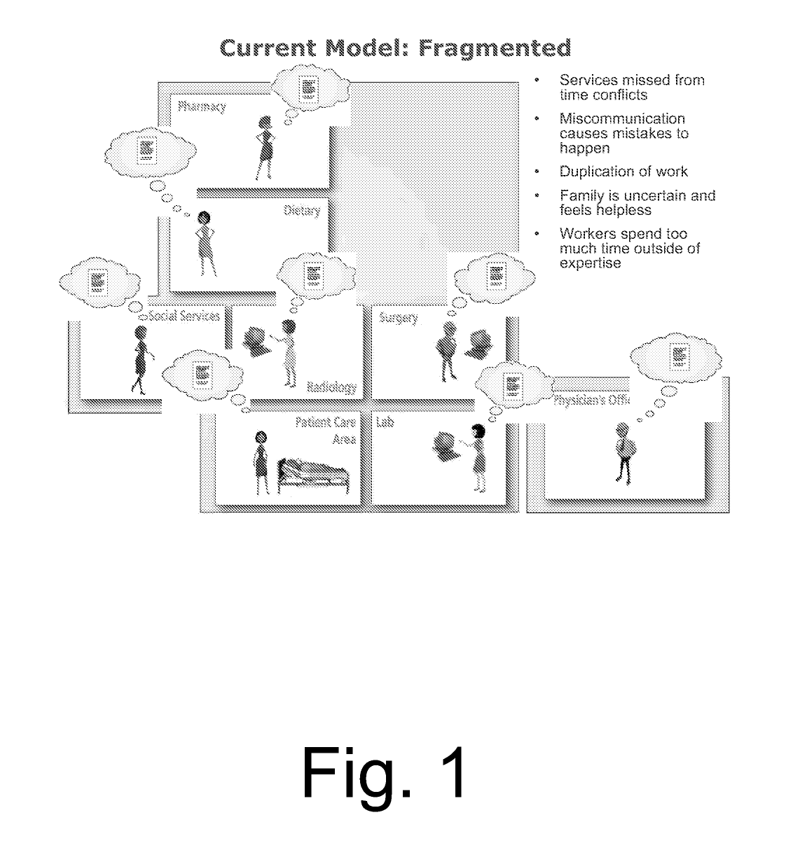

### DESCRIPTION

Implementations provide patient information and communication methods and systems for a healthcare facility to provide a professionally competent level of healthcare to an increasing number of patients with a decreasing number of healthcare workers.

In one implementation, an in-patient hospital room has a hospital bed for a hospital patient. The room has the ability to receiving each of a plurality of views of the in-patient hospital room in real time audio-visual (AV) media. This can be done by know AV cameras, and closed circuit TV apparatus. The room also has the ability to communicate each of the views to a communicant outside of the in-patient hospital room. Each room is provided with an in-room user interface (UI). This UI is provided with the ability to receive and render real time AV media communication with the communicant, and also with the ability to requesting the initiation of the communication with the communicant outside of the in-patient hospital room.

The in-patient hospital room can also include the ability to monitor a vital sign of the hospital patient, and the in-room UI further can be provided with the ability to receive and render a representation of at least the next scheduled healthcare service to be provided to the hospital patient from a predetermined number of such services. As such the patient will know what to expect of their day at the hospital. The UI might also be used by the patient to render, and place a food order from, a food menu of food selections.

The camera in each room can be remotely adjustable, such as by a patient care advocate (PCA) operating a work station, as discussed below, so as to receive each of the plurality of views of the room, but wide angle and zoom (close up). As such the patient, or other person in the room, can be talking via the AV camera in the room and an AV camera at the work station of the PCA. A device, such as a touch sensitive screen in the room by the patient can be used to request this kind of two-way real time AV communication with he patient's assigned PCA. The touch screen can also be used by the patient to input the patient's subjective pain level category for communication to the patient's assigned PCA.

As mentioned above, a PCA operates a work station to keep in touch with the PCA's assigned patients. The patients assigned to the PCA need not all be in the same healthcare facility or hospital, but can be in geographically dispersed locations.

At each such work station, apparatus is provided to selectively receive and render a plurality of real time AV feeds from a respective plurality of the in-patient hospital rooms in a hospital. The work station can also adjust, for each of the in-patient hospital room of the PCA's assigned patients, the views of the rooms that are being captured by the respective AV cameras. The work stations, with the in-room cameras, facilitate a real time AV media two-way communication with a communicant outside of the in-patient hospital room to a communicant inside the in-patient hospital room. By way of example, the work station can allow the PCA or other healthcare provider to communicate with the patient.

Optionally, the work station can selectively receive and render for viewing by the PCA on a display screen any view of any in-patient hospital room for patients assigned to the PCA. The PCA can select among the requests of patients received by the work station as to which of the patient-requested two-way communications to begin or to terminate. Such as selection can be made, for example, by a switch at the work station, or by a toggle icon on a display screen at the work station.

The PCA can use the work station to see other requested made by assigned patients. For example, if an assigned patient uses the in-room touch sensitive display screen to place a food order or to select an entertainment title such as a movie or music album, the PCA will see the patient-placed order at the work station.

An another option, the PCA can operate the work station to view, for the PCA's assigned patient and their respective in-patient hospital rooms, monitored vital signs of the patient in the hospital bed, a subjective pain level category that has been input by the hospital patient (e.g.; such as by entry at the touch sensitive display screen), and at least the next scheduled healthcare service to be provided to the hospital patient from a predetermined number of the scheduled healthcare services for that patient. As mentioned about, the PCA can remotely operate the in-room cameras and microphones to view and hear events of interest to the healthcare of the patient. These sites and sounds can be further directed by the PCA, via the work stations, for deliver in interactive communications with third party sites, such as the patient's off-site physician or family member. Also, a recording can be made of these sights and sounds as they occur for use in the hospital patient's medical records.

In other implementations, a hospital or healthcare facility is provided. The hospital has many in-patient hospital rooms each of which has a hospital bed for a hospital patient. A remotely AV camera captions views of the in-patient hospital room in real time audio-visual (AV) media, which are in turn communicated to a communicant outside of the in-patient hospital room—such as to a work station operated by a PCA assigned to the patient. Inside each room, a user interface (UI) provides the patient with the ability to request, receive and render real time AV communication of the communicant outside of the in-patient hospital room.

At the work station, the PCA can remote adjust each in-patient hospital room AV camera so that sites and sounds can be selective received and rendered at the work station, on storage media, or shuttled to another media outlet for a two-way real time AV communication session. Again, these communication sessions can be requested by the patients assigned to the PCA, which requests are received and selectively acted upon at the PCA's work station by the PCA. Thus, the PCA need only directly communicate in real time AV with just one assigned patient or other in-room person at a time.

A patient can use their in-room UI to find out the next schedules next scheduled healthcare service, or all of such services that have been chronologically planned to be provided to the hospital patient over a time period of their hospital stay. The patient can also input and send to their assigned PCA a subjective pain level, as well as a food order or request for in-room entertainment (e.g.; TV show, a motion picture, a music performance, an educational video about the patient's upcoming schedules healthcare service including the patient's required steps to prepare for the same, etc.).

Given the foregoing, the Figures will now be discussed relative to various implementations that involve a system having a control center. By way of example, and not by way of limitation, a control center can be in communication with any number of hospitals and work stations being operated respectively by PCAs assigned to many patients in the hospitals, where each patient has an input and output device by which communications with their assigned PCA can be requested. Note, however, that the PCA will preferably not be a nurse at a nursing station for the patient's hospital room. Rather, the nursing staff, in-room input/output devices, PCA and work stations will preferably be operated in the various implementations as discussed below in reference to the Figures.

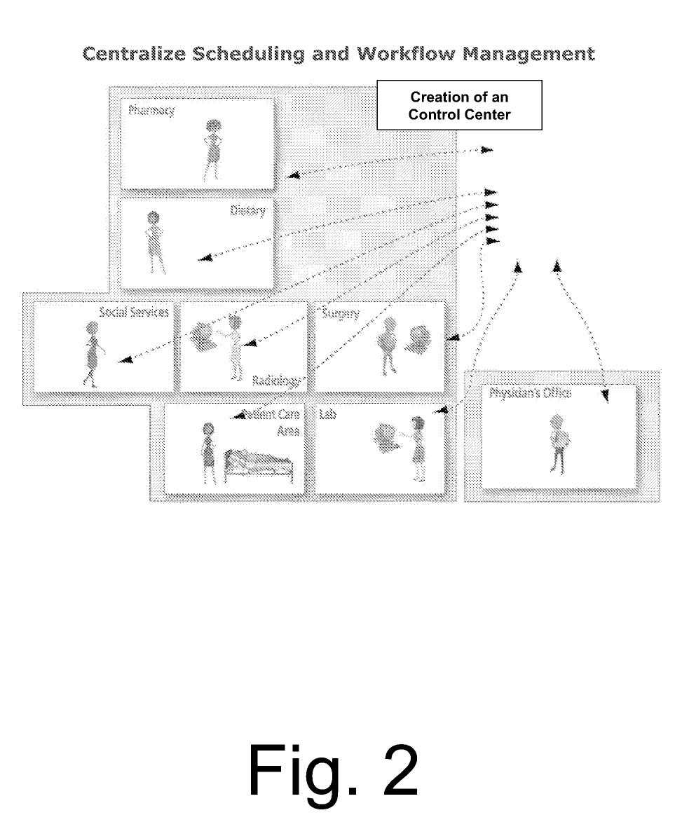

FIG. 2 shows a system having a control center that provides an interface for each of the departments of pharmacy, dietary, social service, radiology, surgery, patient care areas, lab and physicians offices. The control center keeps a list of tasks that are to be accomplished for each department for each patient to whom healthcare services are being provided by the healthcare facility. The control center, when serving as a keeper of such tasks, further provides a centralized scheduling and workflow management that replaces the fragmentation of responsibility for tasks as is known in the prior art. The control center acts as a nucleus for all information and tasks. Terminals provide a user interface to the control center to different ancillary and support areas of a healthcare facility. A communication freeway of information is enabled by the control center to permit coordination of tasks, optimization of workflow, and communication at all relevant levels. The control center allows the free flow of communication such that, for instance, nursing or radiology no longer has to make multiple phone calls to multiple different areas to get answers to their questions and to seek information, but rather can use a terminal and user interface to communication with the control center to get answers and information.

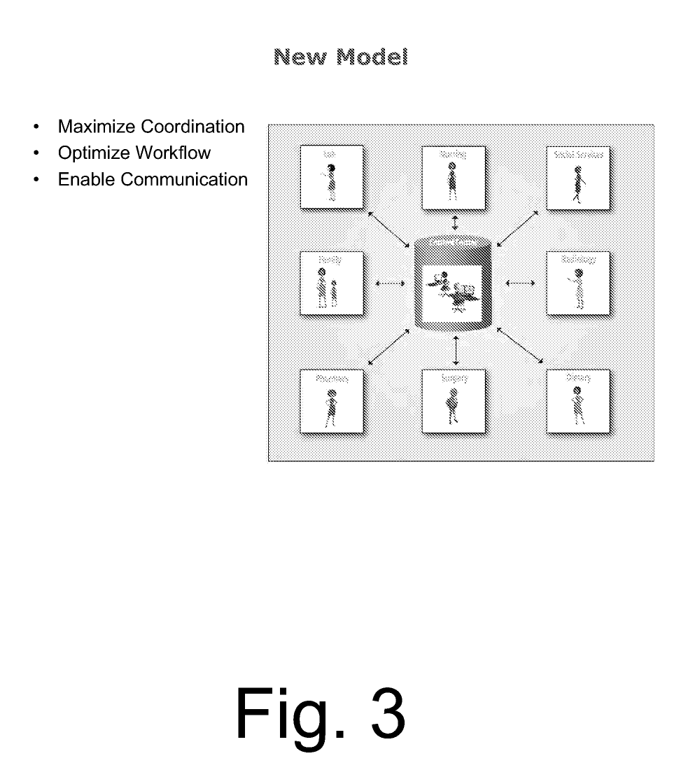

FIG. 3 shows two persons at work in the control center, one of which is a Patient Care Advocate (PCA) and the other of which is a stenographer to type dictation of verbally dictated healthcare services that have been provided to the stenographer. The dictation, once typed, can be stored in an electronic medical record of a patient to whom the healthcare services were provided.

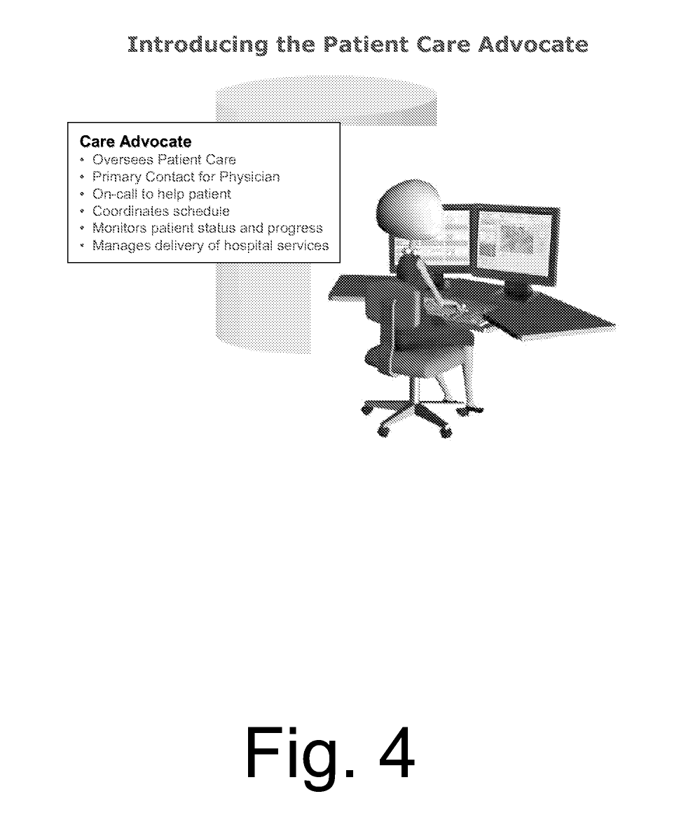

FIG. 4 indicates the functions performed by the Patient Care Advocate, including overseeing patient care, serving as a primary contact for physicians, being on-call to help patients, coordinating schedules for patients, equipment, and systems, monitoring patient status and progress, and managing delivery of hospital services. The Patient Care Advocate works in a ‘control center’ and is provided with tools to know what a patient's healthcare treatment workflow is to be and how that workflow is to happen. The Patient Care Advocate also has two way audible and visual communications with patients' rooms and workers in the healthcare facility. For instance, the PCA is charged with answering calls from each patient. These calls come from a system that allows the patient to press an alert button that signals that they need assistance of some sort. Prior art call alerts required a floor nurse to first see a light on the patient's doorway and then answer the patient's call. Present implementations provide for the call alert from the patient coming into the control center so that the Patient Care Advocate can answer the call light within a targeted time. The PCA can do so immediately because the PCA sees the patient and the patient can see the PCA while having a two way communication session. The PCA may be accompanied by an assistant, referred to herein as a ‘Flight Controller’, who can be seated next to the PCA in the Control Center.

The PCA can communicate directly with a physician of patient, whereas prior art healthcare facilities required a physician to find nurses on a floor of a healthcare facility—often by telephone. As such, the physician's telephone call may be prolonged by being put ‘on hold’ while an effort is made to find the nurse being sought by the physician. In the present implementation, communications are centralized so that the physician can call into the Patient Care Advocate who can take orders for a patient's healthcare service and write the orders into a centralized electronic system. Once entered into the centralized electronic system, the patient order can be electronically sent as a task to a healthcare worker who can complete the task (e.g.; deliver the care). The Patient Care Advocate, as seen in FIG. 4, looks at a ‘dashboard’ on a display screen which serves as a user interface to accomplish the role of the PCA.

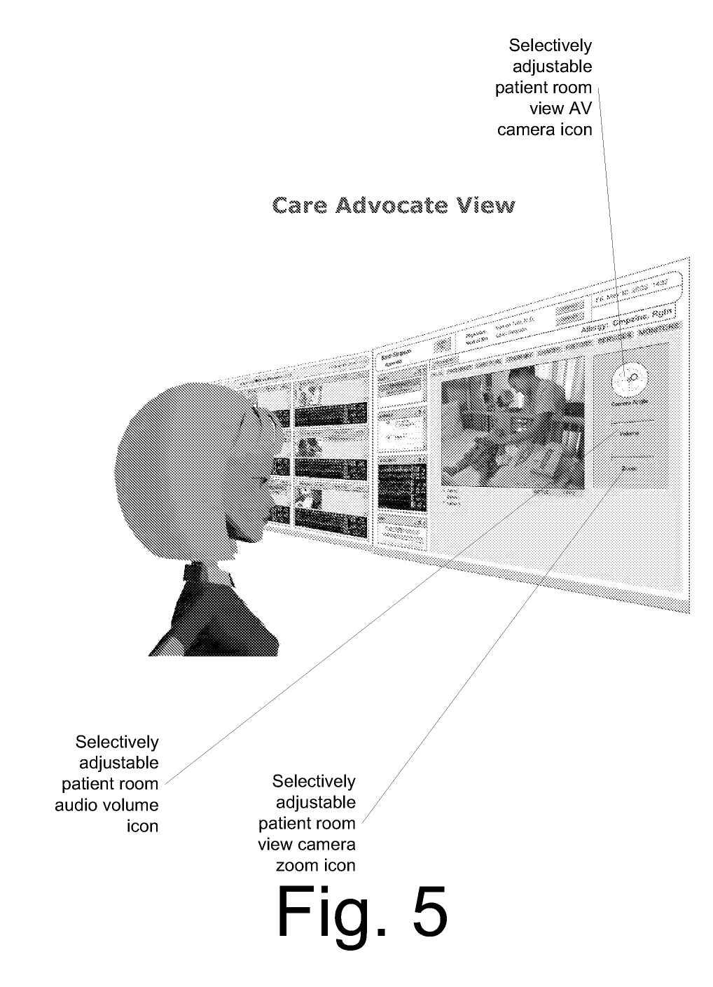

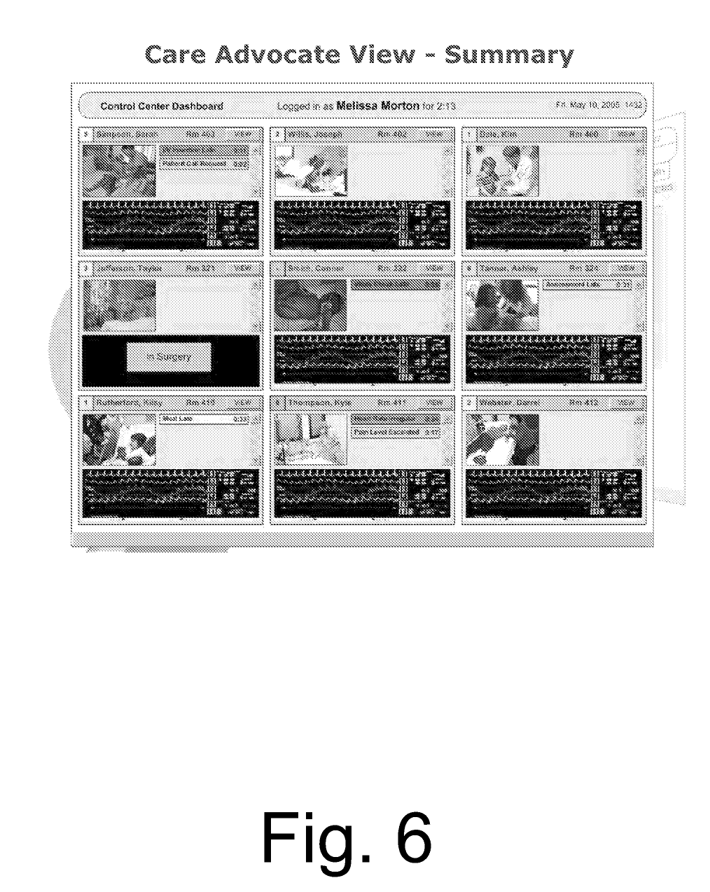

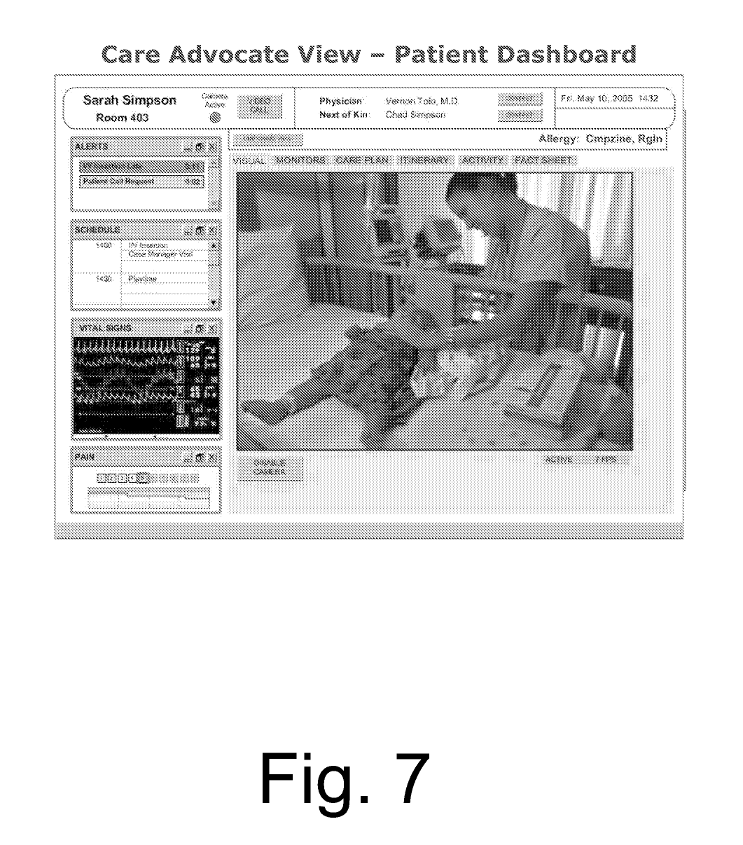

FIG. 5 shows the PCA and a closer look at the dashboard which has at least two (2) displays in the user interface. The left display, as also shown in FIG. 6, shows information about all patients being monitored by the PCA. The right display, as also seen in FIG. 7, shows information about just one of those patients, including a software controlled program for aiming a camera in that patient's room. Note that the work station display for the PCA includes selectively adjustable icon functions to selectively adjust site and sound captured by AV cameras in the patient's hospital room.

The Patient Care Advocate, by use of the dashboard, can see the patients being monitored while looking at each patient's vital statistics at the same time. The right display, as shown in FIGS. 5 and 7, allows the PCA to focus in on one particular patient with camera in the patient's room.

FIG. 7 shows the right display of the dashboard which presents and depicts information about one (1) patient only. The Patient Care Advocate might call up this display for this patient if the patient's call light or alert goes on and the PCA needs to answer the light, of if the PCA is monitoring the patient's vital statistics remotely by the dashboard and the PCA sees a change in the patient's condition as indicated on the dashboard. For instance, the PCA might call up the right side display if a floor nurse or physician asks the PCA to talk to the patient. As such, the PCA can be part of the physician's or nurse's ‘rounds’ to understand and communicate with the patient.

As seen in FIG. 7, the PCA is viewing a scene captured by a camera in a pediatric patient's room in which a nurse is taking care of the pediatric patient. The PCA is visualizing that scene because, either the PCA wanted to look at the assessments being done by the nurse or the nurse had asked for some assistance from the Patient Care Advocate. The dashboard shows the patient's name, their allergies, the date, the patient's attending physician, and the next of kin. Also shown is a schedule of healthcare tasks that are to be performed for the patient, the patient's vital statistics, and a patient-controlled pain scale. The vital statistics seen on the dashboard can include blood pressure, respiration rate, heart rate, temperature, air line status, intracranial pressure readings, or other statistics from the patient that would be desirable to monitor.

If the PCA is monitoring the pain scale that the patient or nurse is reporting, and the PCA sees that this statistic has gone from a pain scale of a 5 out of 10 and has moved up several points, then the PCA may call in to the patient's room to talk about the patient's assessment of pain with the patient and perhaps suggest an earlier dose of pain reliever than has been scheduled according to the written workflow for the patient. This proactive system of the PCA is better than the prior art system in which nurses lack flexibility due to their responsibility for multiple patients in multiple different rooms.

The user interface for the PCA provides multiple ‘click’ buttons that, once ‘clicked’, provide further information to the PCA. The PCA can also manipulate the camera, as mentioned above, by software controls, including camera angle, volume, and zoom. The PCA can zoom in and be able to see an intravenous (IV) drip rate from an IV being administered to a patient in the patient's room, or the PCA can calculate the drip rate on an IV that is fairly small.

FIG. 6 shows the control center dashboard left display. As indicated in FIG. 6, ‘Melissa Morton’ is the Patient Care Advocate who currently logged in. The date and the time are shown and the PCA can see a distant view of multiple different patients for which the PCA is responsible. The left display also allows the PCA to look not only at each patient's vital statistics, but also allows a look at what alerts have come up for each patient. For instance, for Sara Simpson who is in the upper left hand corner, her IV insertion is late by 11 minutes. Her patient call request is shown as being turned on for two (2) seconds, which means the patient has actually turned on her call request. The system can be configured to require that each patient's call request be answered within a period of two minutes, and if the call is not answered within this period, then the system will render a different and more serious alert after the two minute period.

Tasks not administered within a predetermined time period are judged by a workflow software routine in the control center. As such, the system indicates when a task is supposed to happen, and if it wasn't answered or triggered by someone as being completed after a certain duration, then a warning light is turned on, audible alarm is sounded, and/or an electronic diagnostic message is sent (e.g.; via electronic mail). The task completion warning aspect of the system allows the healthcare facility to make sure needed care is delivered in a timely fashion by assigning tasks with built in triggers that go off when those tasks are not completed within a predetermined time frame.

FIG. 7 shows a daily schedule for at particular patient, where the schedule is derived from a workflow. Tasks on the schedule are compared against the time of day to determine whether alerts should be issued. The alerts tab and display allows the PCA to set thresholds on a task. For instance, if the schedule indicates that an IV is going to be started within 30 minutes after an order for a particular healthcare service has been provided to the patient, then the ‘monitors’ tab would be the function that the PCA would operate to set this threshold prior to the issuance of an alert. Other than the alert thresholds, the PCA can also change the units of measurement by activating the monitors tab.

The vital sign graphs and numerical statistics are shown in FIG. 7 as is a patient-operated pain scale display. A tab labeled ‘visual’ allows the PCA to turn the in-room camera on and off.

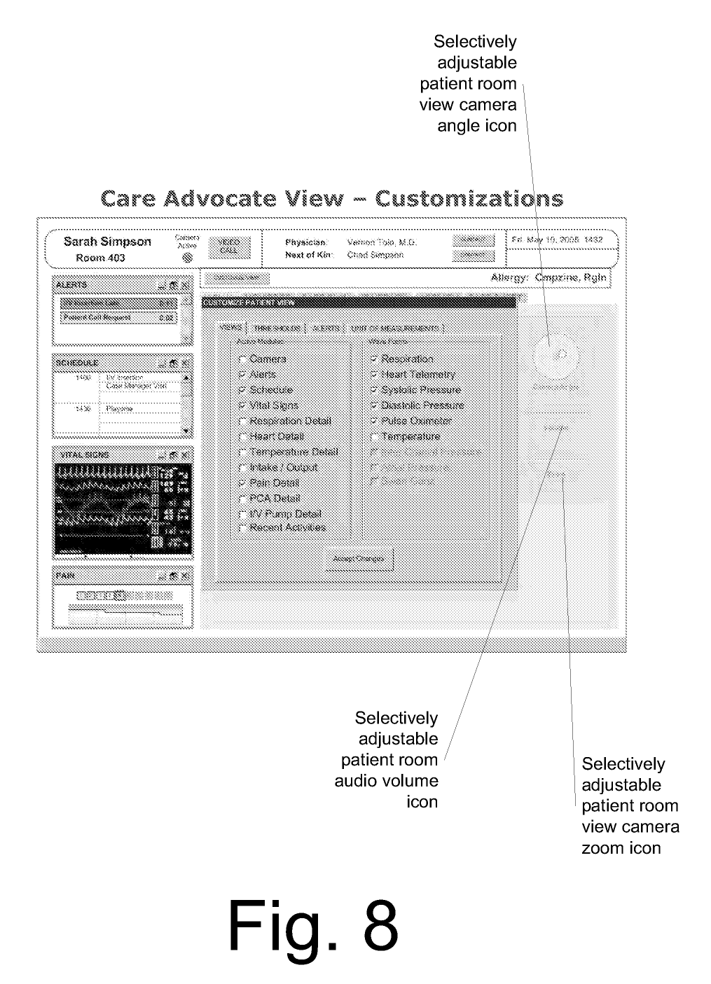

FIG. 8 shows a display screen that can be viewed by the PCA after the customize view tab seen in FIG. 7 has been activated. FIG. 8 shows a user interface display scene for use by the PCA so that a customized patient view can be configured by the PCA to display data that the patient is going to need to have monitored, thereby allowing the PCA to customize what is to be seen about the patient on the dashboard. Thus, the PCA can set parameters for vital signs or measurements wanted for a particular patient, and how often the measurements are wanted. Bedside electronic equipment can feed measurements into an electronic record with minimal human data entry. The customized view can include the patient's fluids intake and output and how often this is to be measured. The system can be configured to automatically have a data dump into the system for fluid intake, fluid output, net fluid balance, patient weight, where fluid pumps and the patient's temperature automatically interface with and make input into the patient's electronic medical record. Note that the work station display seen in FIG. 8 for the PCA includes selectively adjustable icon functions to selectively adjust site and sound captured by AV cameras in the patient's hospital room.

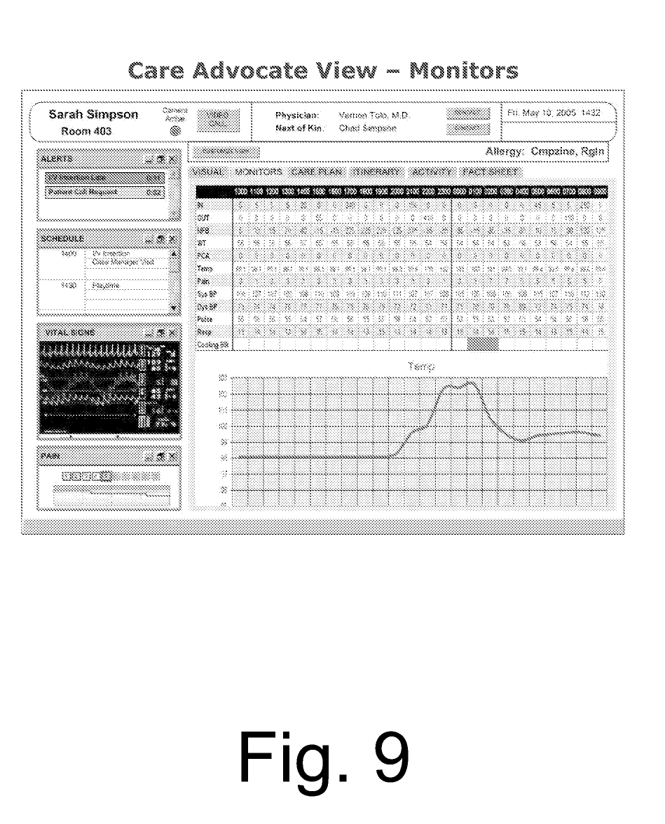

FIG. 9 shows a display screen viewed by the PCA after the monitor tab seen in FIG. 7 has been activated. Hours of the day are displayed on this screen as a continuum of 24 hours per day and 7 days per week monitoring. In the box at the first row and column, an indication is shown that 5 cc of fluid had been taken in by the patient orally (e.g.; by drinking water or juice or other fluid). The row label “OUT” for the first column shows that the patient has not passed any fluids, and the ‘NFB’ row for the first column shows the difference the intake and the output. The ‘WT’ row for the first column shows the patient's weight, which can be obtained by a scale that is integral to the patient's bed and has an electronic output signal that communicates the patient's weight. For example, an infant's bed may have this capability to weigh the patient-infant.

The ‘PCA’ row for the first column shows Patient Controlled Analgesia, which is a measurement of an IV pump that allows the patient to have some control of the delivery of narcotics to the patient for the patient's pain management. Also shown are the patient's self-indicated pain, and regular body temperature that is taken every hour on the hour.

For each statistic being monitored, a graph can be rendered at the bottom of the display screen as shown in FIG. 9 for the patient's body temperature. Both physicians and nurses can see these monitors at other display terminals in the healthcare facility and can request a graph displayed to see trends in the data being monitored. For instance, a graph of self indicated pain can be requested to be displayed by a physician or one of the nursing staff so that a historic trend of adequate pain relief can be assessed for a period of time that is in the middle of the morning, yet will also show poor pain relief at a different period of time.

FIG. 9 further shows chronological data for systolic blood pressure, diastolic blood pressure, pulse, and respiration. A cooling blanket indicator shows that a cooling blanket was applied to the patient who, for instance, may be running a high fever, and where the temperature of the cooling blanket is to be monitored.

The right-most column, which is shaded, shows the present hour to be 9:00 o'clock in the morning, where the left columns show historic data for the patient over the last 23 hours. As a row is high lighted by the PCA's operation of the dashboard, the graph of data for the last 23 hours is displayed in the lower portion of the screen. Alternatively, the PCA may be able to see data on this display that had been acquired prior 23 hours ago, of for instance such as three days ago. In sum, the monitors tab on FIGS. 7 and 9, when activated, will show the PCA or other healthcare staff with proper access credentials, a historical view of the data being monitored.

The care plan tab seen in FIG. 9, when activated, would show a critical pathway display (not shown) for both nurses, physicians, and other healthcare workers that reveal past and outstanding tasks in the provisional of healthcare services for a patient. These tasks for the patient come from an ‘order set’ which contains information on how a patient is to be treated. The care plan for a patient essentially allows an assessment of healthcare services that have been provided to the patient during a hospital stay, healthcare services presently being provided to the patient, and healthcare services that are planned but have not as yet been provided to the patient during the in-patient stay at the healthcare facility in order to complete all planned healthcare treatments.

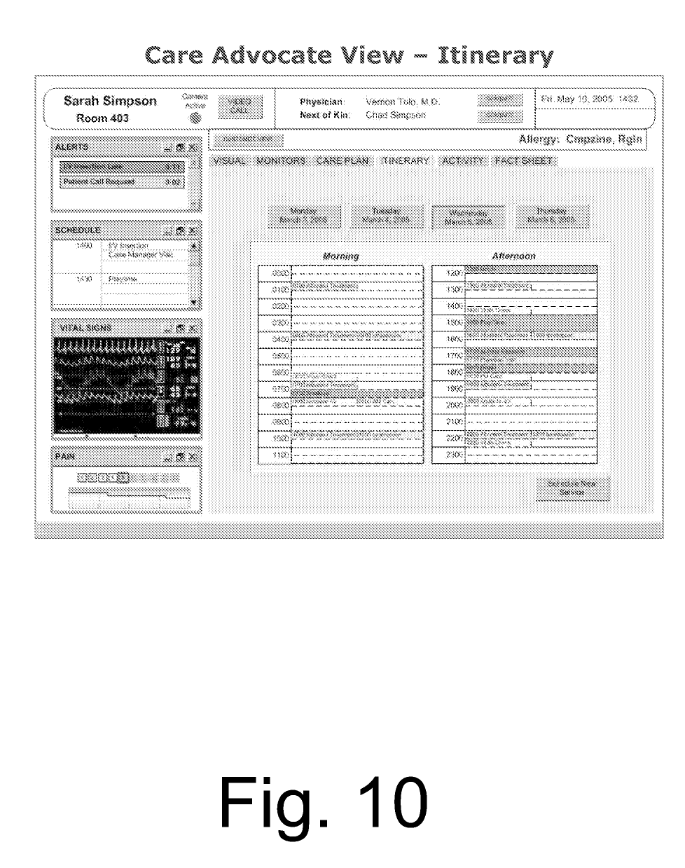

By activating the itinerary tab on FIG. 9, the display seen in FIG. 10 is rendered on the dashboard. The itinerary is the patient's schedule behind the care plan that is generated off of the order sets, where the schedule is produced by considering the critical pathway for nursing staff (not shown) who also care for other patients. Thus, the critical pathway displays data for multiple patients, whereas the itinerary is a display for just one patient. For instance, the itinerary may indicate that at 1:00 o'clock in the morning the patient is to receive an albuterol treatment, which also means at 1:00 o'clock in the morning the patient can anticipate a respiratory therapist coming into the patient's room and delivering the albuterol treatment. Both patient and staff have access to the patient's itinerary.

Contrasting the care plan with the itinerary, the care plan would not necessarily show everything that is happening to the patient, such as tests being performed on the patient's blood in a laboratory. The itinerary, however, would show a task of drawing blood from the patient to be performed at a particular time. Thus, the care plan is a more comprehensive display of how care is to be provided to the patient.

The itinerary in FIG. 10 shows the patient and staff that at 6:30 o'clock vital signs need to be checked and that the patient's breakfast is going to come at 7:30. The itinerary for Wednesday Mar. 5, 2005 is shown, as indicated by the shaded tab, and itineraries for three (3) other days can also be shown by activating the respective tab. If a physician orders a chest X-ray on Monday to be performed in two (2) days, the patient's itinerary should reflect that added task on Wednesday at a particular time which can be automatically calculated by the control center by taking into account the outstanding demands for x-rays ordered for other patients.

The tab labeled Schedule New Service on FIG. 10, when activated, allows the PCA to schedule a new service that might not be interconnected to the control center. So, if a chest x-ray was ordered, but for whatever reason the electronic scheduling system can't pick out a date or a time that matches when the physician wants it, then the Patient Care Advocate would need to contact Radiology, troubleshoot the unavailability of x-ray resources, come up with an alternative time, and the PCA may have to go in and enter the chest x-ray task manually. Note, however, that manual entry of tasks is an exception to the order set specification of predetermined tasks which ordinarily drives each patient's itinerary and critical path of healthcare tasks. The order set for each patient, when received, is preloaded into the control center, although non-medical task such as meals and play time for children may not be placed on an itinerary for a patient by a physician, but rather by a PCA or a floor nurse.

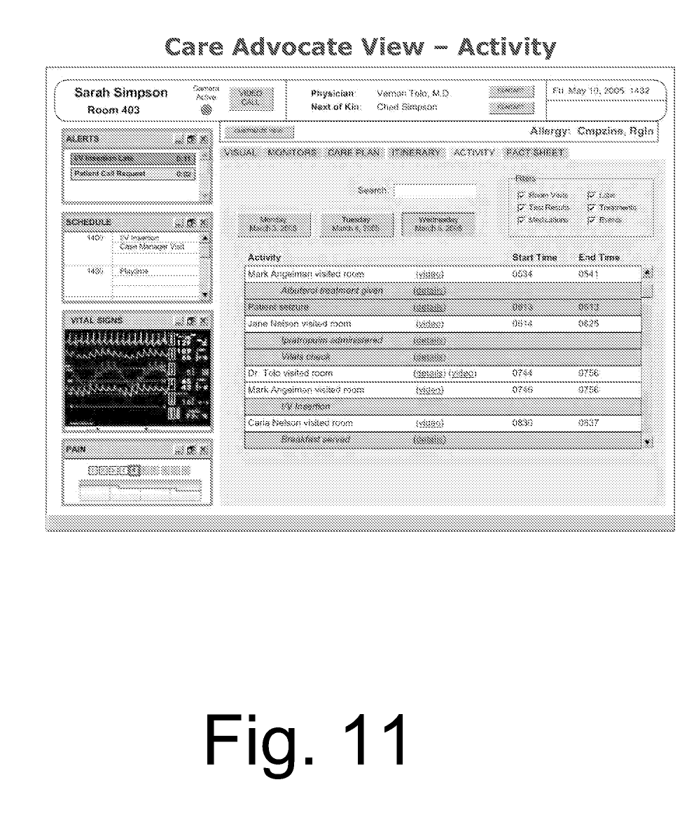

The activity tab in FIG. 10, when activated by the PCA, will cause the display shown in FIG. 11 to be rendered. The display in FIG. 11 shows a log of healthcare workers that have entered and/or exited the patient's room. This log is made possible by a radio frequency identifier (RFID) device worn by each worker and an RFID detector in each patient's room. A log entry is made in the log when the RFID detector senses an RFID signal and identifies the worker by the information carried by the detected RFID signal. For instance, each of the staff members or any of the workers that are taking care of the patient would have an RFID badge, and when they enter and/or exit the patient's room, the RFID signal will be automatically be picked up by an RFID detector and feed into the patient's electronic medical record. By way of example, FIG. 11 shows that Mark Engleman, a respiratory therapist, visited the room. A video capture can be automatically made when Mark Engleman's RFID badge is detected. The video capture ends when Mark Engleman's RFID badge is no longer being detected (e.g.; he has left the patient's room). As such, each health care worker's work after entering the room is captured by video and audio and date stamped, and then entered into a database associated with the patient's medical records. Upon examination of the audio visual record, a determination can be made as to when an albuterol treatment had been given to the patient. The video capture can be reviewed to assess the extent and quality of services rendered by Mark Engleman. Additional activities can also be logged, such as when the patient enters or exits the room, in which case the patient can also wear an appropriate RFID device.

Importantly, a proximity sensor or other electronic intrusion detection device can be used in the patient's room to determine that a human being has entered the room who is not wearing an appropriate RFID device. Appropriate and predetermined audio visual cues and alerts can be then set off for handling by the PCA or other staff, such as a security department or unit.

While a healthcare worker is in a patient's room, the worker can do an oral dictation of services rendered. The dictation can be made into a microphone alternatively attached to the worker's person or within the room itself. Voice recognition transcription and/or human transcription of the oral dictation can then be made for later association with the patient's medical records. The scheduling display on the left side of FIG. 11 can be compared with the activities logged by scrolling these displays, for instance to confirm that an albuterol treatment was due at 5:30 in the morning to be delivered by a Doctor Engleman.

In the upper right corner of FIG. 11, a series of check boxes are associated with filters which, when checked or not, control the types of activities that are to be displayed on the activities display screen. These filters include options to display room visits, test results (e.g.; for radiology, chest x-rays, CT scans, MRI scans, etc.) Of course, other check boxes and filters for the display of other activities can also be added beyond those seen in FIG. 11.

The check boxes can also control whether an audio visual capture is to be made of each visitor's visit to the room. If the room visits filter is checked, an alert can be issued and activity of the same recorded while an audio video rendering of the visit is displayed on the dashboard for the PCA to watch. Family members, doctors, and anyone with an RFID tag would be so treated. Activities logged that involve entering or leaving a room include the doctors rounds, medications being delivered, lab samples being drawn, the delivery of lab test results coming back into the patient's room, treatments done to a wound, etc. Alternatively, some data need not be acquired for patients having only a brief in-patient stay. As such, the filters would not be set so that data would not be collected, in that it adds no real value to the patient's healthcare treatment.

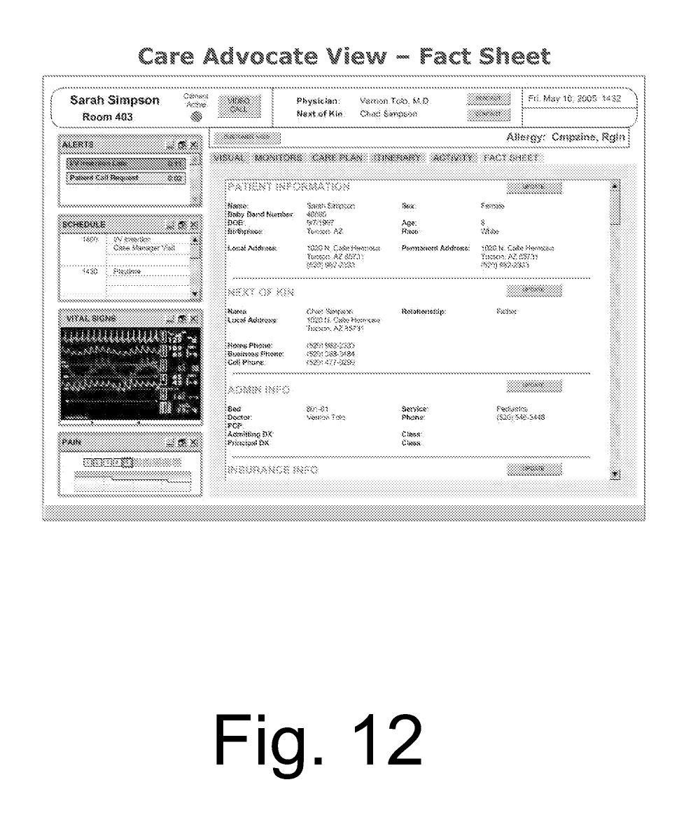

FIG. 11 shows a fact sheet tab which, when activated, displays the rendering seen in FIG. 12. FIG. 12 shows information derived from the patient's electronic medical records. This display allows numerous healthcare workers within the health care system that are caring for this patient to have simultaneous access to patient information, including next of kin, administrative information, and insurance information. One example of this needed access is that of a case manager. A case manager helps with a patient's discharge planning and helps the patient arrive at home and have the treatments that they need at home.

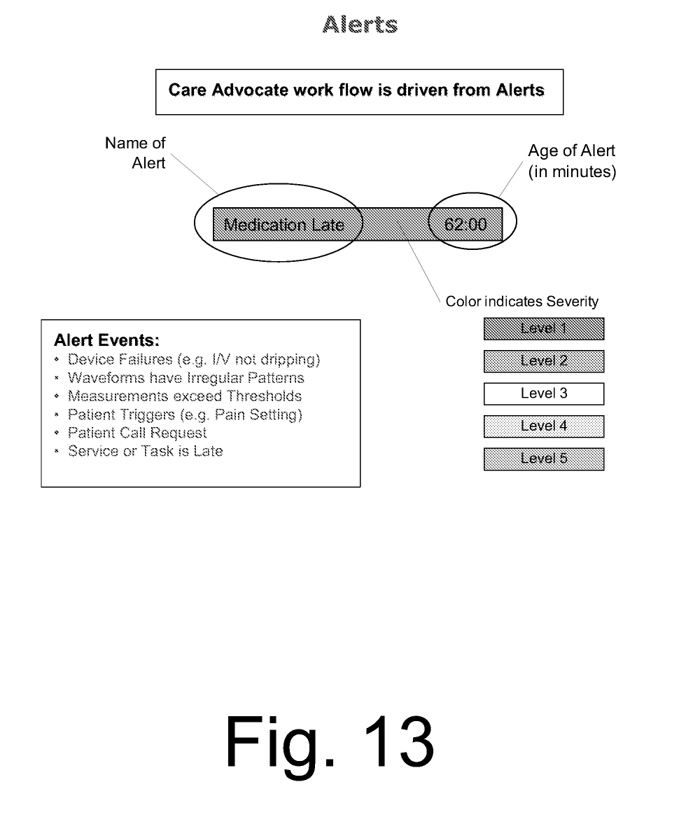

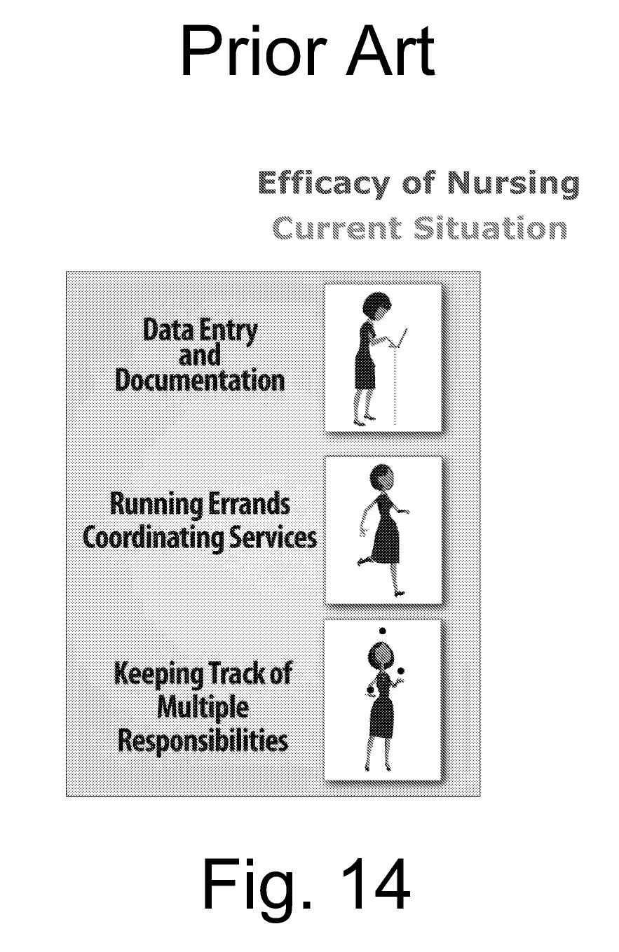

FIG. 13 shows alerts from which workflow for a PCA is driven. Alert events might be device failures, such as an IV that is not dripping, wave forms which might have irregular patterns such as EKG's, measurements that exceed predetermined thresholds (e.g.; a medication is timed to be delivered at 9:00 o'clock with a threshold of 30 minutes and a lateness alert is to issue if delivery has not been made within the 30 minute threshold), a patient triggers a high pain situation, a patient makes a call or sends a request to the PCA, or a service or task is late. Alerts can be shaded, numbered, and/or color coordinated as to severity, such as red as the highest level of 1, orange at level 2, yellow at level 3, green at level 4, and blue at the lowest level 5.

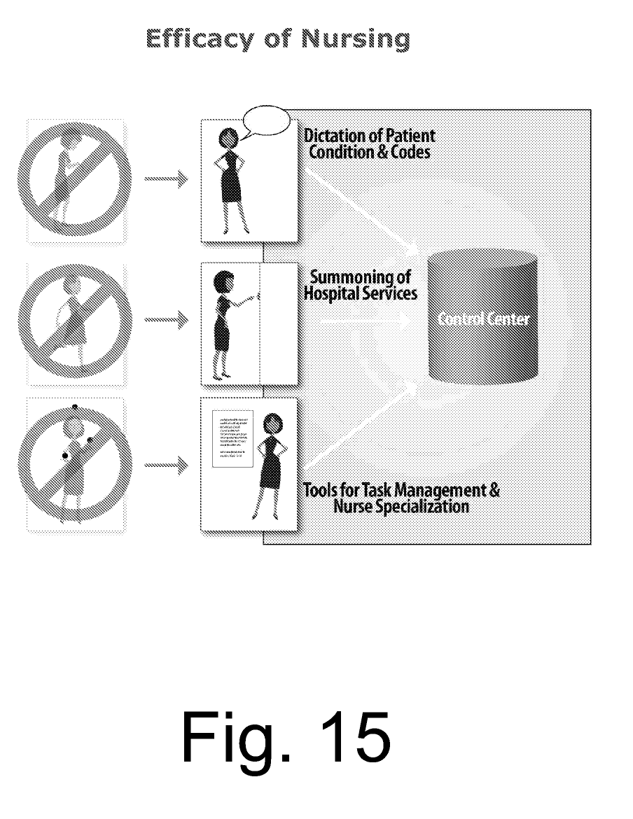

FIG. 15 shows several low skill tasks that will not be performed by highly skilled healthcare workers in implementations of the inventive healthcare facility, including data entry and documentation, running errands and coordinating services, and keeping track of multiple responsibilities. Rather, a healthcare worker will input information to a control center that will coordinate the delivery of needed services and tools for tasks to be accomplished on behalf of a patient. These tasks include the typing by a stenographer of a nurses' dictation of an oral transcript detailing services rendered by the nurse to a patient and their condition, as well as the summoning of hospital services. As such, nurses need not call each department from which services for a patient are required (e.g.; radiology, pharmacy, physical therapy, etc.).

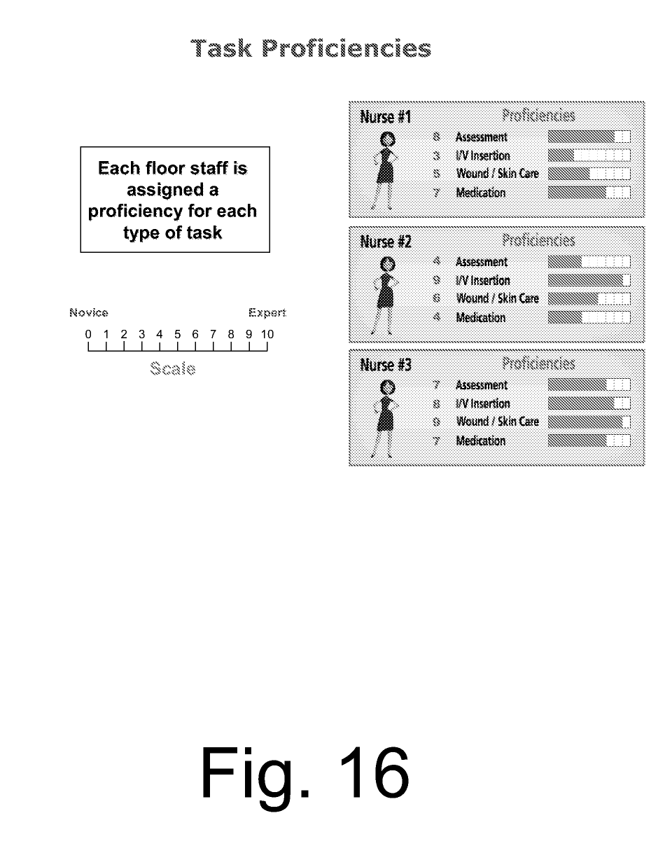

FIG. 16 shows a scale against which each nurse is numerically and graphically assessed as to proficiency is each of several nursing tasks. These tasks include assessment of a patient's pathologies, intravenous (IV) needle insertion, wound and/or skin care, and administration of medications. In order to deliver the best quality care to patients, a control center can automatically schedule, or a PCA can manually schedule, a task to be performed to each of several patients in a department or unit, where the assignment is made according to the nurse that has the highest proficiency in the task that is to bee assigned. For instance, one nurse might be highly proficient at starting IV's, whereas another nurse might be highly proficient at inserting nasal gastric tubes. The control center stores proficiency ratings for each healthcare worker for each healthcare task, and the tasks are scheduled accordingly. This allows a Patient Care Advocate, a nurse manager, a nurse educator, and others in management to ask less proficient workers to observe and be coached by highly proficient workers as they perform their scheduled proficient tasks. In this way, the observers might develop higher proficiencies in the healthcare task delivery being observed.

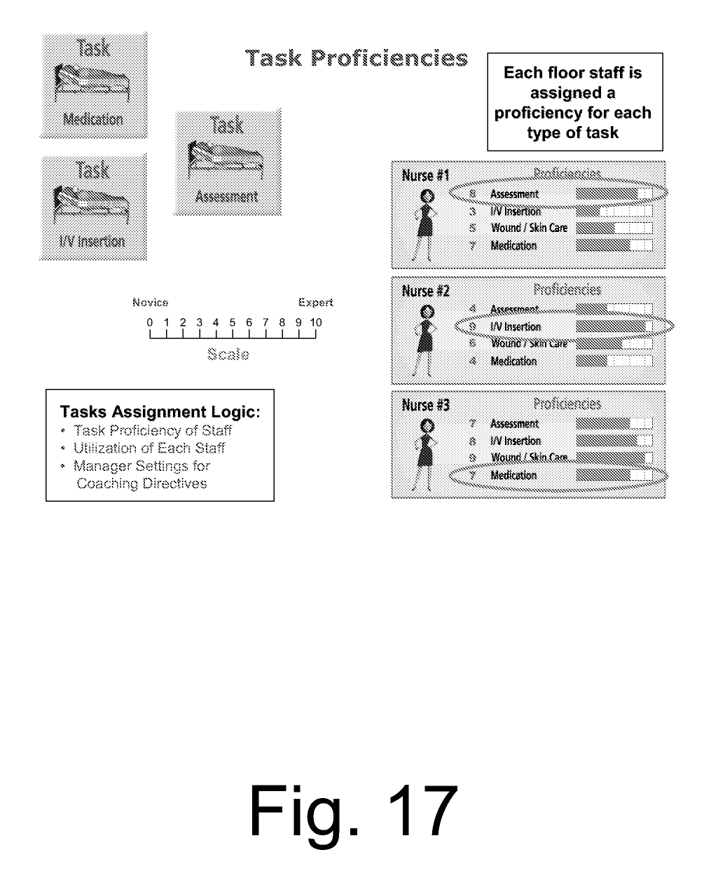

FIG. 17 shows the scheduling of tasks according to proficiency as indicated by the ovals made for Nurses #1-#3. In practice, a PCA may have a user interface to ‘drag and drop’ an assignment of each task to be scheduled for multiple patients in a unit to those nurses in the unit according to the proficiencies displayed to the PCA on the user interface. Alternatively, as mentioned above, a workflow routine operating in a control central may automatically assign these tasks by a similar algorithm.

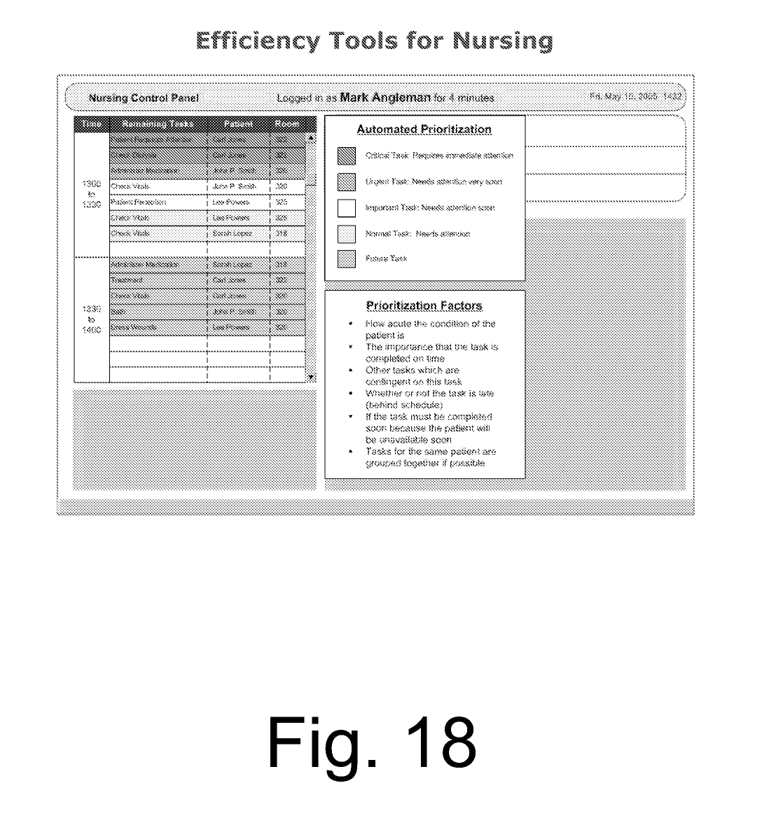

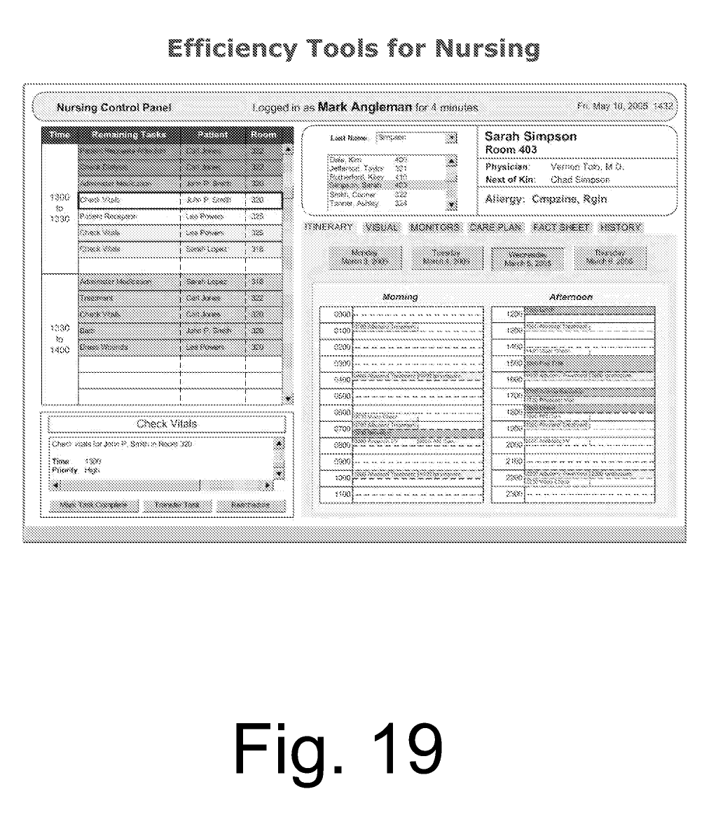

Each nurse sees the tasks that have been assigned to them as shown in the Nursing Control Panel shown in FIG. 18. FIG. 18 is a display that illustrates tools being observed by a nurse that have been made available in implementations of the present invention and that provide efficiencies for nursing functions. These tools are shown, at least in part, by the Nursing Control Panel which is more particularly illustrated in FIG. 19.

The Nursing Control Panel in FIG. 19 shows the nurse to be Mark Angleman who has been logged in for 4 minutes. Mark's patients' names and outstanding tasks are seen in the left display, which can be scrolled down. Once a patient's name has been located, the nurse can ‘click’ on it to then show another display which is the patient's specific dashboard such as is seen in FIGS. 7-12.

Each scheduled task for the nurse is displayed on the left side of the Nursing Control Panel. The time that the tasks need to be performed within are shown, as are the remaining tasks. The priority of the tasks can be shown by shading and/or color coding. The patient and their room are also shown. As such, the nurse need not make hand written notes of outstanding tasks and their relative priority. The Nurse Control panel serves as a task master that prioritizes work within the half hour or hour according to what needs to be done first. Accordingly, the higher priority task ‘float’ to the top of the Nursing Control Panel and are indicated as such by numbers, shading, and/or color. As shown in FIG. 19, the redder the color, the higher the priority, and the bluer the color, the lower the priority according to the acuity or severity of the tasks to be performed. For instance, checking vital signs or the reception to a new patient to a unit may not have as high of a task priority as delivering dialysis to a patient. The priority of each task can be set as parameters (e.g.; as shown in the central bottom portion of FIG. 19) in a control center in electronic records used by the control center.

The light colored tasks see by healthcare workers can be designated to be of a low priority, as they are to occur in the future and are not important at the present time. FIG. 19 shows a task to check vitals—meaning that the nurse is to check vitals of a patient who doesn't all ready have electronic checking of vitals, or it might also means that there is a goal to have all vital signs that are electronically monitored to also be manually checked by a nurse by looking on each patient's dashboard without going into the patient's room.

FIG. 19 shows the Nursing Control Panel to include information about one patient on the right side of the display—which is at least a portion of the patient's dashboard as has been discussed above relative to FIGS. 7-12. The lower left portion of the display in FIG. 19 shows a task to check vitals of the patient John P. Smith, which corresponds to the highlighted border around the itinerary item ‘Check Vitals’ seen at the time of 1300 for John P. Smith. This task now is separated from the rest of the tasks and shows what the nurse is presently doing, namely checking vitals for John P. Smith in room 320, at 1:00 PM o'clock which is an important priority task as per the chart seen in FIG. 19. When the nurse clicks on a task, others may see what the nurse is doing. The nurse can mark the task as complete when the nurse has finished the task. Then, the start, finish, and staffing of that task is entered into the electronic medical record of the patient. Alternative, the nurse or the PCA can transfer the task to another nurse, reschedule the task for a later time, as shown by the three tabs below the display of the task presently shown in the bottom left of FIG. 19. By transferring or rescheduling the task, an alert may be avoided due to lateness of when the task was originally scheduled to be performed.

In the upper right corner of the display seen in FIG. 19, the nurse's dashboard shows the patient, the room, the physician, the next of kin, and the patient's allergies. The particular patient shown corresponds to the pull down menu of patients assigned to the nurse that is in the top center of the display. The nurse, here, wishes to see the assigned patient Sara Smith and has clicked on Sara Smith from the pull down menu which in turn causes the patient's dashboard to be presented on the Nursing Control Panel. That dashboard includes the patient's itinerary and other information about the patient. As such, both the assigned nurse and the PCA can see the patient's dashboard, and the PCA can see the nurse's Nursing Control panel.

The nurse or the PCA can input non-patient related tasks to the Nursing Control Panel, such as going off the unit. Alternatively, these tasks can also be scheduled automatically through a control center having a workflow routine for nurses and patients.

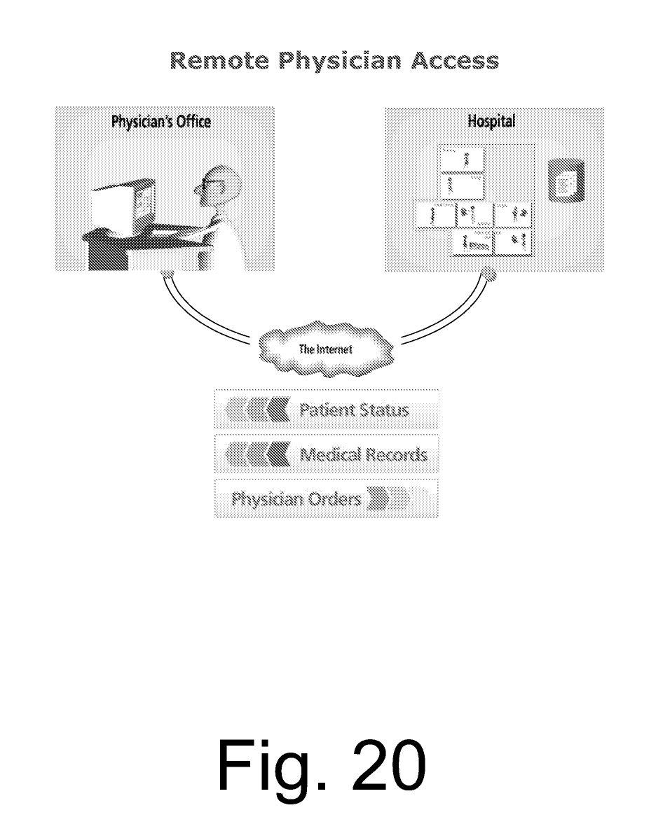

FIG. 20 shows a display that indicates the integration made possible by a control center in implementations of the invention. This integration of services includes the provision of patient status and medical records to and from both local and remote physicians, as well as the receipt of orders from a patient's physician via remote physician access. A physician is seen sitting in an office, remote from a hospital and its control center, where the physician and control center communicate through the internet FIG. 20 indicates that the physician is interconnected through a network (e.g.; the Internet) to a database of medical records at the control center of the hospital for each department of the hospital. As such, the physician need not be dependent on calling a unit or department at the hospital to seek information such as access to a patient's electronic medical record or to look at the patient's status.

In addition, the physician can send electronic physician orders so that the physician need not give verbal orders or telephone orders to a nurse, thereby reducing a risk of error. Rather, the electronic physicians order is a visual record for a nurse to view without having to input the data in the order. The order can then be reviewed and manually or automatically be input into the workflow of the hospital, its nurses, its staff, and its patients. In some cases, a PCA may need to determine whether the hospital has sufficient capacity to accommodate an electronically received physician's order. Then, the PCA can interface with the physician to assure that orders received can be entered into the control center system when capacity exists.

The physician can remotely see and review a patient's status and other medical records, see and talk to the patient in the patient's room via the patient's dashboard (discussed below), and enter orders for healthcare services to be performed at the hospital, thus making virtual ‘rounds’ of the physician's patients at the hospital. This not only avoids a trip to the hospital but also avoids finding or calling a nurse to implement a physician's order. In some cases, however, the PCA will have to talk to the physician to coordinate orders for the physician's patients.

Before a patient is admitted to a healthcare facility, preorders of physician orders can be made and fed into the control center. Then, workflows are calculated by the control center for the healthcare facility across all patients scheduled in the future for in-patient services. These orders are referred to herein as order sets, where all order sets for a coinciding time period must be coordinated into cooperating workflows by the control center. This coordination may require the modification of an original order set for one patient in order to accommodate other order sets of other patients.

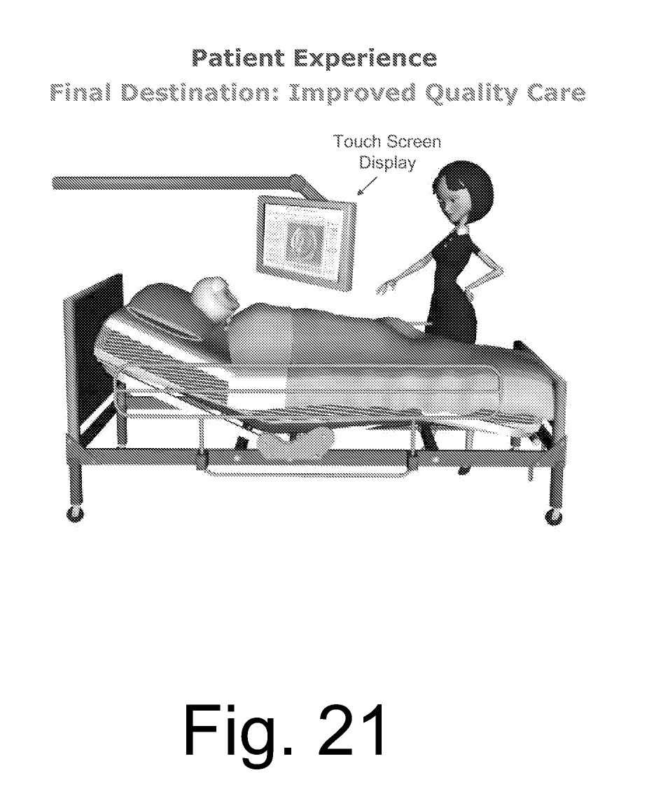

An implementation of the invention showing the patient experience is seen in FIG. 21, where a patient has an interactive dashboard or Patient Portal displayed on a screen in the patient's room in which a nurse is also present. Note that FIG. 21 show that interactive dashboard to be accommodated by a touch sensitive display screen easily assessable to the patient from the hospital bed as well as to a floor nurse seen at the patient's hospital bed. As such, either person can operate functionalities of the patient portal on the touch sensitive display screen.

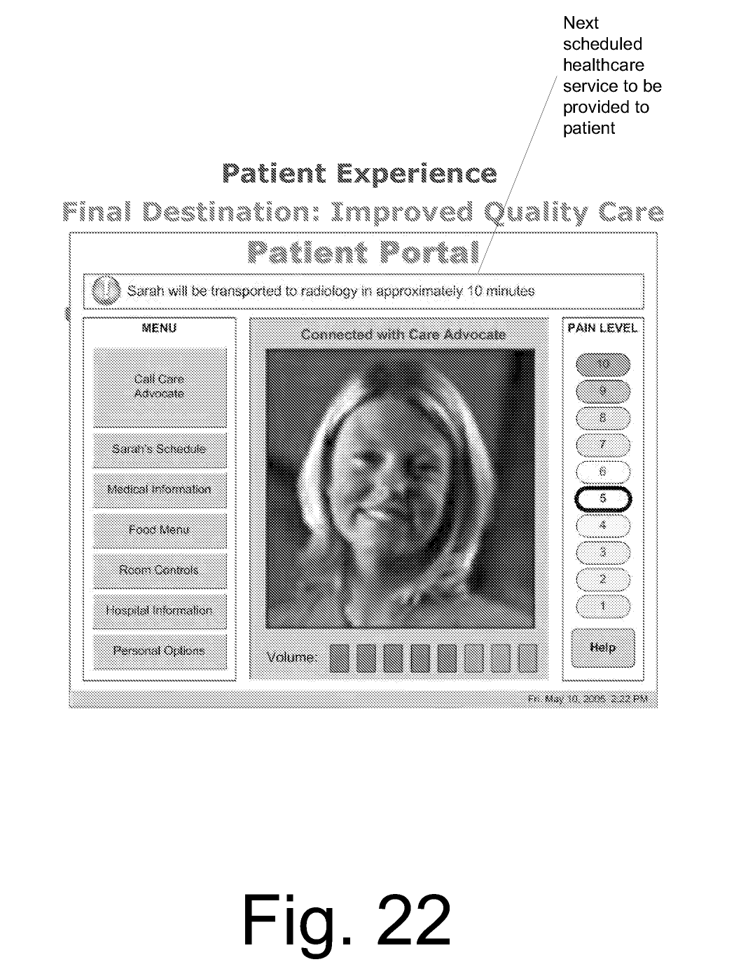

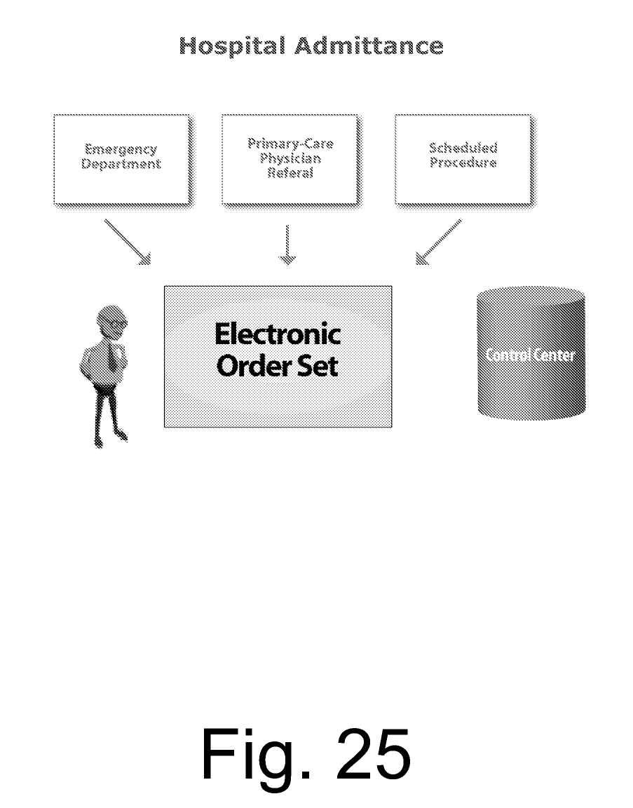

FIG. 22 shows the Patient Portal more particularly, which includes a plurality of tabs that can be activated by input from the patient to initiate a variety of corresponding functions. The Patient Portal improves the quality of care given by use of an electronic system that may include a touch screen display suspended near and above the patient's bedside. Preferably, the user interface on the Patient Portal will be simple to operate and have large input function tabs. Of course, a handheld remote control might also be operated by the patient to make input to the Patient Portal. Note that the next scheduled health care service to be provided to the patient is displayed on the patient portal display screen. By of example, the patient's scheduled health care services can be drawn from the scheduled procedure from an electronic order set, discussed below with respect to FIG. 25. The Patient Portal can also render real time AV media of a two-communication that the patient is having with their assigned PCA, as well as the patient-input subjective pain level which is also seen by the patient's PCA. Being able to both see and talk to a healthcare provider, such as the patient's PCA, can be comforting to patient's who are otherwise waiting with concern for a next-scheduled healthcare service that is to be provided to the patient. Moreover, a floor-nurse need not be present with the patient to comfort and explain the service to the patient as this function is being fulfilled by the patient's PCA via the Patient Portal.

As discussed above, the Patient Portal allows the patient, upon demand, to see electronic display of their daily schedule in a simple itinerary that is the same schedule seen by the staff. Moreover, the data on the Patient Portal might also be made accessible via the Internet to the patient's family and physician. The patient used by example in FIG. 22 is Sarah and the screen shows a tab that can be activated by Sarah on her Patient Portal to show Sarah her itinerary (e.g.; the itinerary may show Sarah that she will be transported to radiology in approximately ten minutes). Given the patient an itinerary for the day also gives patients cognition of when to expect goods and services in an otherwise unpredictable environment. As such, the patient will know in advance when a gurney or wheelchair will arrive to take them out of the room. The patient may then plan to have personal chores accomplished without interrupting or delaying scheduled tasks. As such, the itinerary puts both staff and patient on a mutually understood schedule so that each goes where they are supposed to be and can plan accordingly. Of course, the patient may also be reminded of statically computed likelihoods, such as through historic data acquision and queuing theory, that a service or good will be delivered at an exact time as well as how early or late the delivery might be.

The Patient Portal in FIGS. 21-22 shows that the face of a PCA is visible to the patient in a mutual audio visual communication session, where the patient can control the sound volume as shown on the user interface in FIG. 22. On the right hand side of the user interface the patient may input their perceived pain level as well as a need for immediate help.

On the left side of the user interface is a menu, the largest tab of which (the ‘Call Care Advocate’ tab) can be used by the patient to request an audio visual mutual communication session with the PCA. This tab can be activated by touching it. The PCA in turn answers the call. Movement compromised patients who are unable to touch the screen may be provided with a remote control device near their pillow or other assessable area. Other tabs correspond to menu selections for a patient to select to see their scheduled itinerary, have access to their medical information, order food from a menu, control lights and room temperature, draw the curtains, close the shades, view hospital information and educational video presentations, and well as play computer games, purchase pay-per-view entertainment to be displayed on the screen, pursue personal correspondence through an electronic mail service (e-mail), explore Internet websites, etc.

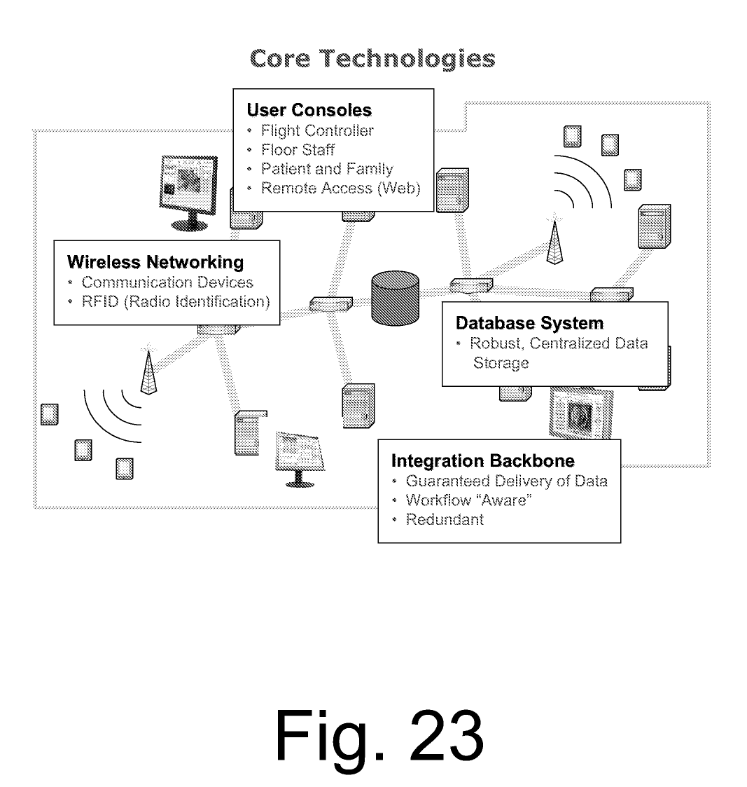

FIG. 23 is shows an exemplary implementation of a control center having a database system, an enterprise or integration backbone, and a plurality of wireless networking devices and user consoles. Preferably the enterprise or integration backbone will be aware of all workflows past, present, and future, provide redundancy to avoid data loss, and guarantee delivery of all data being generated for communication among different units of one or more healthcare facilities and those communicating with them.

The backbone shows servers and routers to facilitate communications. A centralized storage is accommodated by the database system. RFID devices are carried by staff, equipment, patients, and visitors. These serve as wireless networking devices that are interoperable with the wireless networking capability of the backbone, as are other wireless communication devices such as cell phones, desktop and tablet personal computers, personal digital assistants, cellular and satellite telephones, small form factor expert systems, wireless audio and video devices, wireless unidirectional and omidirectional microphones to receive dictation of medical services, etc. As such, for user consoles, including both the nurse's and physician's dashboard, can be facilitated as a hand held wireless system. By way of example, a physician may use a cellular telephone to remotely review the physician's patient's status and medical records and then communicate a physician order for entry into the patient's workflow by the control center. The physician's dashboard may also be configured and enabled to click on a task indicating surgery, which would then link to a live audio visual feed of the surgery being conducted in a surgical theatre, including options to view different cameras in an endoscopic surgically procedure. Depending on access levels to the control center, members of a patient's family may be able to use the Internet to have an audio visually communication with the patient in the patient's room, as well as see the Patient Portal.

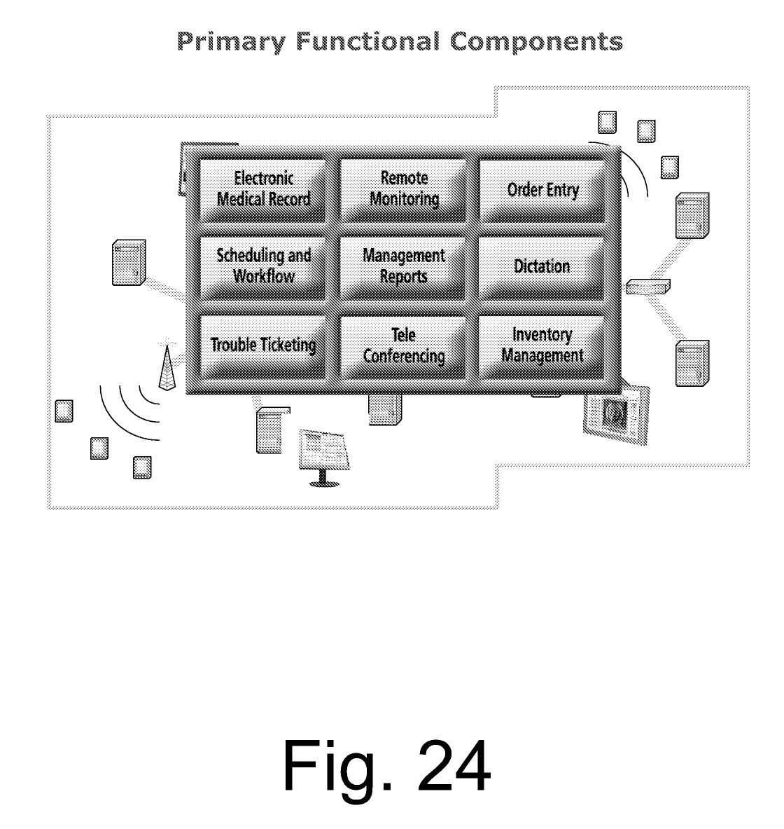

Communications with the backbone also are provided for off site disaster recovery and storage of large amounts data such as audio visual feeds from patient rooms and surgical theatres for each patient, which data can be made part of the respect patient's medical records. FIG. 24 shows the primary functional components which can be used in the control center seen in FIG. 23. These primary functional components include the electronic medical record, remote monitoring, order entry, scheduling and workflow, management reports, dictation, trouble ticketing, teleconferencing, and inventory management. These are the sub-systems that can be executed on the backbone.

While other primary functional components are self-explanatory, trouble ticketing involve situations where a repair is requested, such as for heating, ventilation or air conditioning. An actual electronic ticket is generated upon the request, which begins a monitoring process as to progress on the repair, while obviating the need to repeatedly check back by telephone to assess the status of the repair after it has been submitted. Teleconferencing provides an ability to speak to rural and out-of-state physicians as well as to staff in their offices. Inventory management numerically depletes supplies according to tasks scheduled in workflows that requiring the same. This coordination permits the demands on inventory of those supplies to be forecasted to enable timely reordering of those supplies when an electronic trigger is activated when the supplies fall below a predetermined par level. The trigger may also automatically send out an alarm to a supply center wherever a supply in a particular department is getting down towards its par level at a certain rate of change which, according to a predetermined threshold, the supply needs to be reordered and restocked. This feature of the primary functional components provides a value added streamlined process that allows the units to readily have the equipment and supplies that are needed without being wasteful as to premature or excessive ordering.

As is illustrated by FIG. 25, an order entry provides for an entry of an order set from a physician for the sequence of events required to treat a patient with in-patient healthcare services. As such, the physician's orders will drive the services that are to be provided for the patient's care. For instance, an order entry might be for an order set to treat a patient diagnosed and admitted with pneumonia. The order set might then contain orders for administering an IV of antibiotics every 8 hours, a feeding of a regular diet to the patient, a chest x-ray in 2 days after admittance, and respiratory therapy.

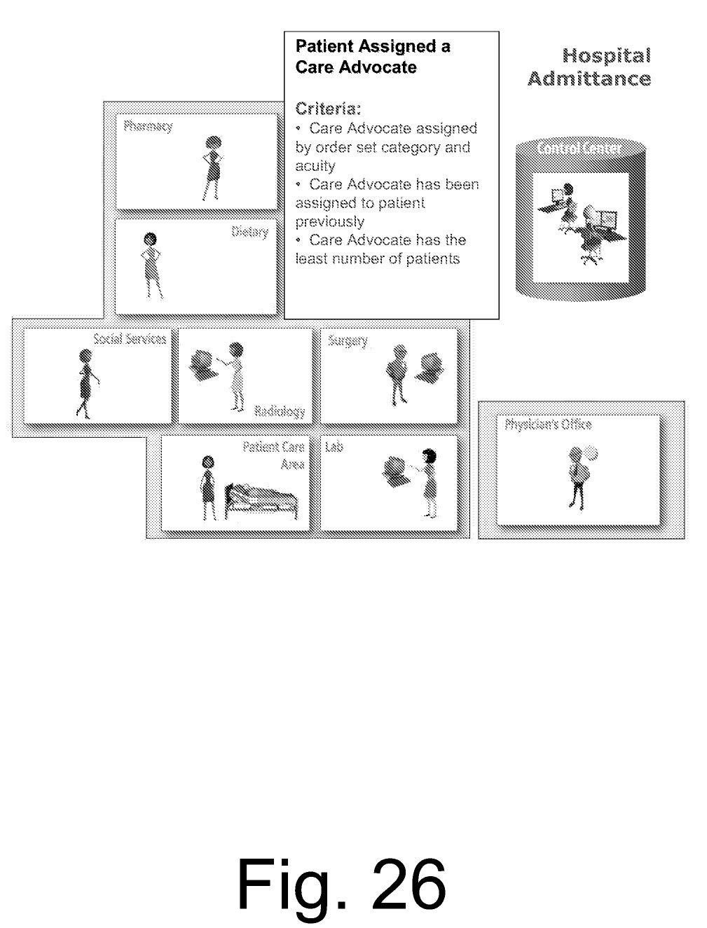

FIG. 26 is a block level diagram depicting an exemplary order set for a patient. The order set may contain tasks for various units including the emergency department, an order entry from a primary-care physician, and various scheduled procedures specific to the treatment of a patient's pathology, all of which involve the patient receiving in-patient services. The backbone of the control center is a master patient itinerary driven electronically by clinical order sets. For example, a patient can come in to the healthcare facility through the emergency department, or a primary care physician referral, or a scheduled procedure. The patient also comes in to the healthcare facility with a diagnosis, such as pneumonia or appendectomy. The control center provides a list of diagnosis or symptoms to select from. By that diagnosis or symptom, the system can determine the tasks that are needed to treat the patient. These tasks are then stored in an electronic order set that the physician can chose from. The electronic order set is evidence based and drives what the physician does, what type of care the patient receives, and what treatments the physician believes that the patient should receive with the particular diagnosis.

In general, the generation of an order set is initiated by the physician or other practitioner. The order sets are added to the patient orders and each task or element of the order set is automatically scheduled by the control center, checking for conflicts, clinical dependencies & resource availability. The electronic order sets drive the schedule of services provided at the hospital for each patient that has been admitted. As the control center schedules each patient's care, the order sets in the control center drive both the patient's itinerary and the hospital's workflow around each patient.

As shown in FIGS. 25-26, an electronic order set gets submitted to the control center, which can involve all ancillary areas of a healthcare facility as well as a remote physician's office. The PCA assigns tasks embedded in the order sets by their category and acuity, where highly needed tasks are prioritized over lesser needed tasks. The PCA will be assigned to a particular patient as other PCAs may be responsible for other patients. To ensure a safe environment of supervising care to a patient, the PCA will be assigned to a preferably small number of patients which can be based upon the acuity of the patients. For instance, a PCA may only be able to adequately monitor forty-five (45) critical care patients, whereas a PCA assigned to adult medical surgery patients may be able to adequately monitor seventy-five (75) patients. A PCA may be assigned only to critical care patients or only to pediatric patients, where the assignment might be based upon the PCA's medical specialty.

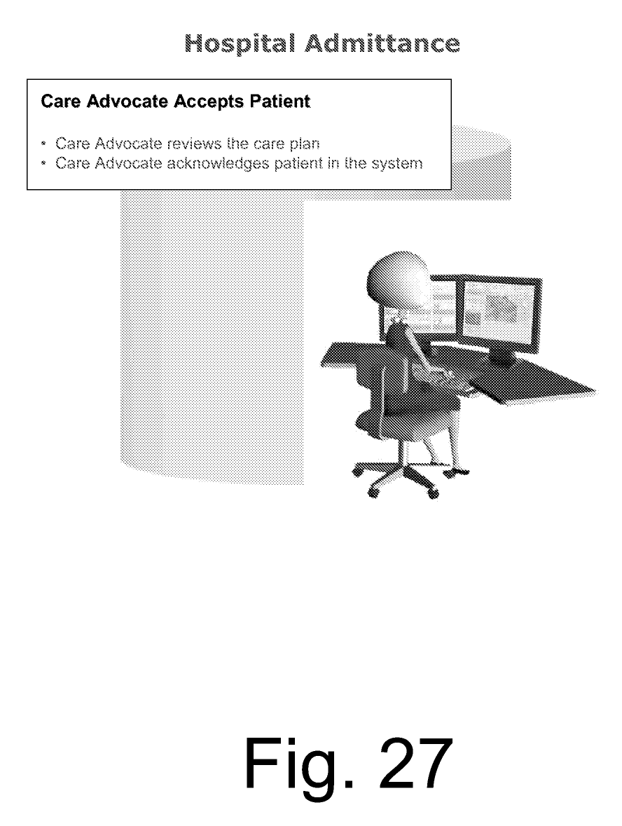

FIG. 27 illustrates an exemplary method involving a control center, where a PCA accepts a patient to be admitted to a healthcare facility. The PCA reviews the care plan and order sets for the patient, and then acknowledges the patient in the system. The Patient Care Advocate is the first one to receive the patient.

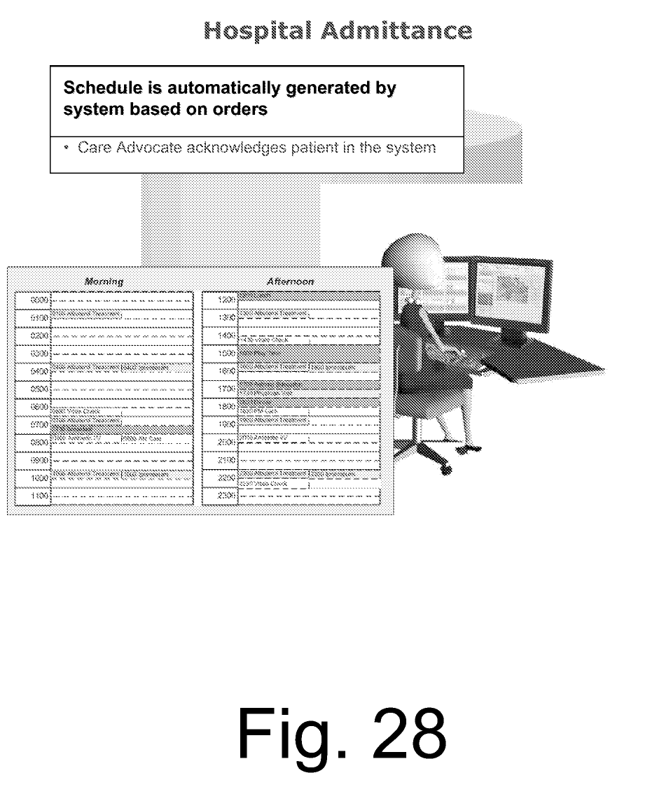

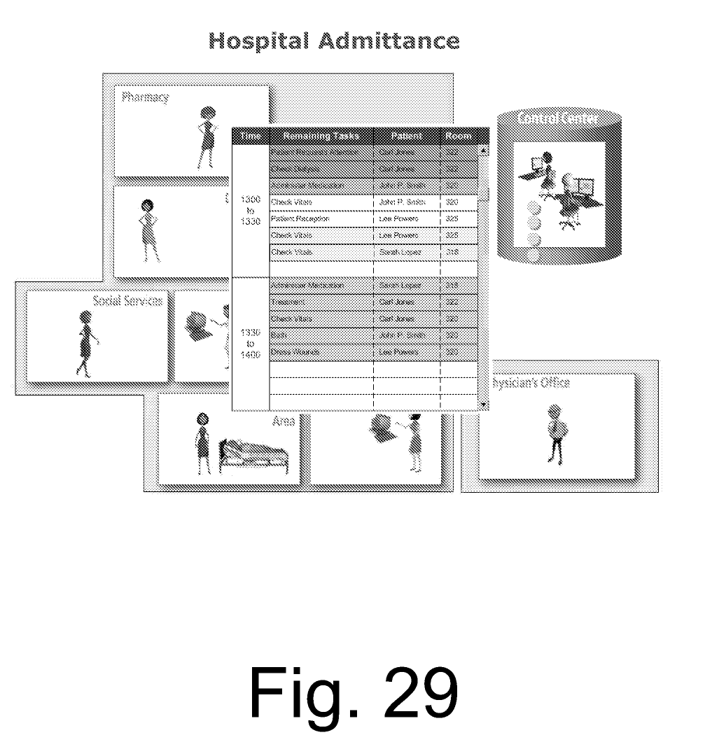

As shown in FIGS. 28-29, when the PCA enters the order sets for a patient into the control center system, the control center system then automatically generates a schedule for the patient based upon the system based upon other order sets that have been entered into the control system for other patients undergoing treatments the healthcare facility on or around the same time that the patient has been admitted. The control center system attempts to find the ‘best fit’ for the patient's schedule given the schedules of other patients.

As shown by the example given in FIG. 29, the control center, after having set the schedule for the patient, sends out the information to all of the service areas that are going to participate in this patient's care. Any of the tasks that have been assigned to that patient will show up as assigned tasks on the respective dashboards of the nurses, physical therapists, pharmacists, etc. The control center thus acts as a task master to tell a nurse that a new patient has been received, and that the nurse has tasks that need to be performed in each of the next several hours. As mentioned above, either the PCA will manually assign tasks, and/or the system will automatically assign tasks, to a particular floor nurse based upon proficiency. For instance, the PCA would be able to view the proficiencies of each nurse and the staff in a unit, make a determination that an 80 year old gentleman that probably has poor veins should have an IV introduced by a nurse who is highly proficient at putting in IV's, while also assigning a task to a less proficient nurse to watch the proficient nurse perform this task as a coaching and mentoring exercise to improve the proficiency of the less proficient nurse.

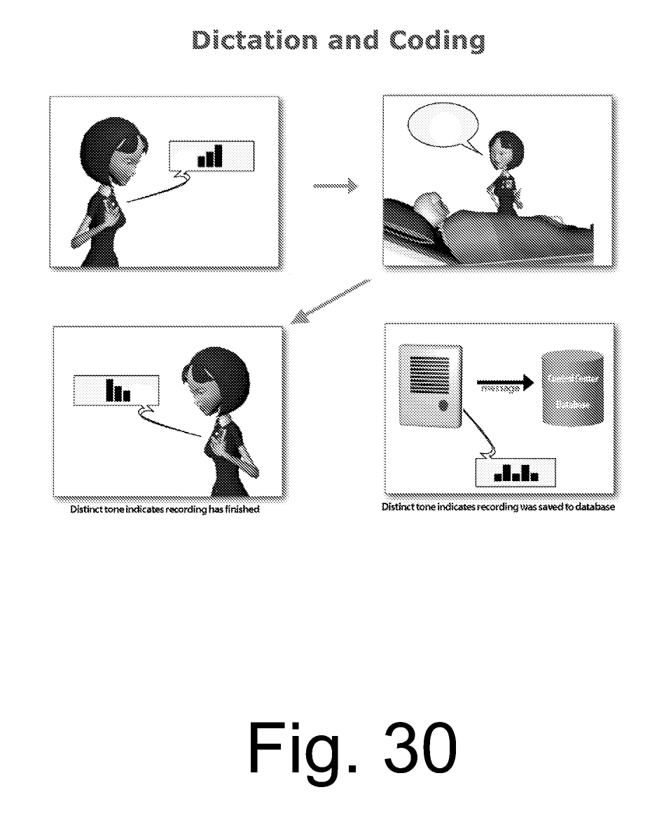

In FIG. 30, an exemplary method is shown for a nurse to dictate a summary of a service provided to a patient or a diagnosis of a patient. FIG. 30 shows a nurse activating a portable recorder, doing a dictation, stopping the dictation, and then saving the recording to a data base. The recording device indicates when the recording has finished so that the nurse will know that the recording has terminated.

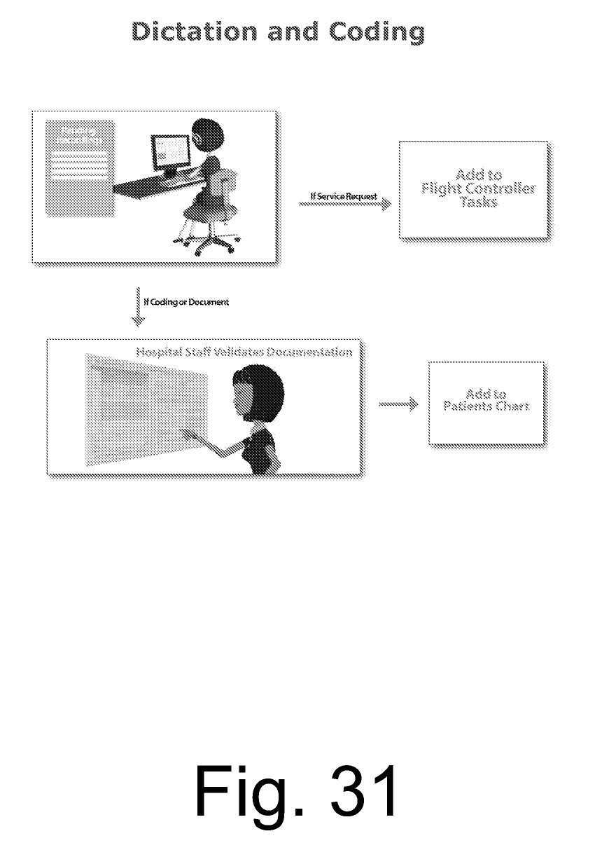

As shown in FIG. 31, the digital coding of an oral dictation is stored for later retrieved by a stenographer for the production of a transcript. The stored dictation is communicated into storage at the control center where it is placed in a queue. A stenographer listens to the recording and actually puts it in scribe. Of course, a nurse could also directly enter a transcript without need of the stenographer. After the stenographer creates a transcript of the nurse's dictation, the nurse reviews the transcript to validate it, approves it, signs off on it, and then the transcript is stored in the electronic medical records of the patient. The task for this recording service is then completed and can be automatically removed for the care plan for the patient.

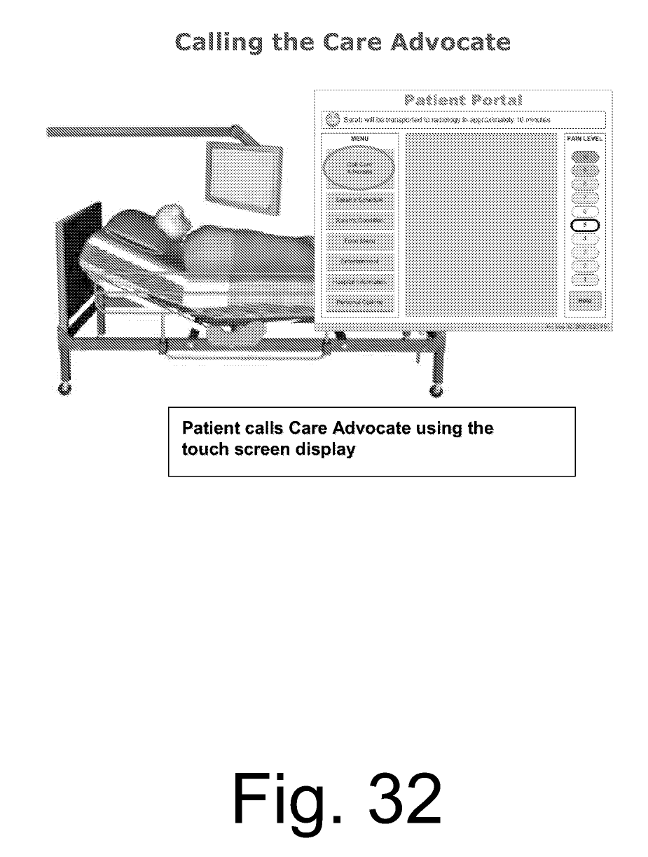

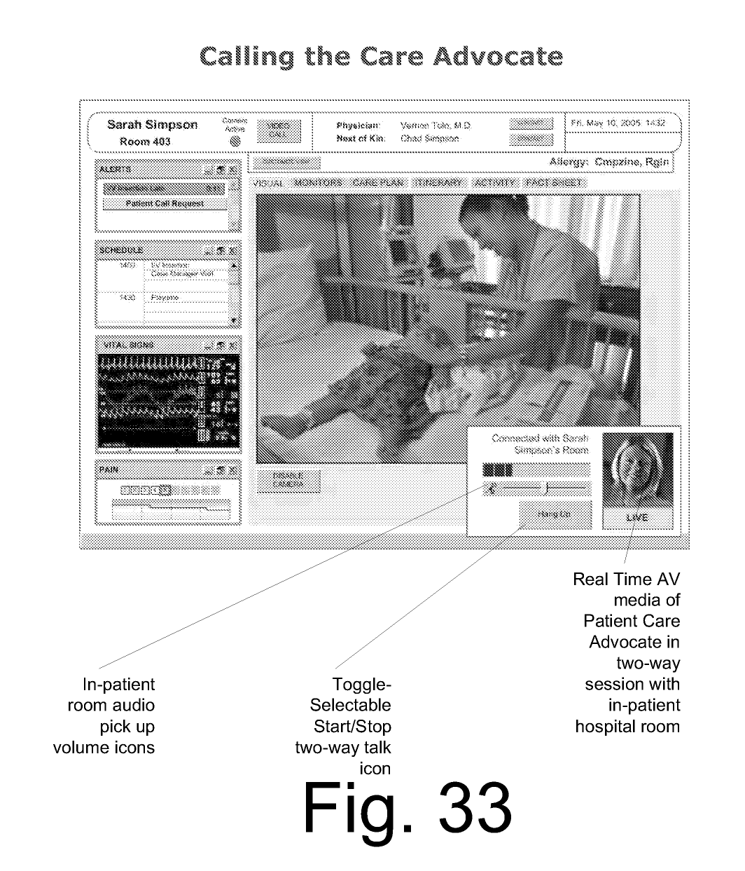

FIG. 32 shows an environment in which a patient can call their assigned Patient Care Advocate using a touch screen display. As shown in FIG. 32, the touch screen display has a ‘Call Care Advocate’ button. When this button is activated by the patient, such as by touching the touch sensitive display screen or by operating infrared remote control device, etc., the Patient Care Advocate sees the screen display shown in FIG. 33 which includes a video feed of the bed in the patient's room and a picture-within-a-picture for an actual video feed of the Patient Care Advocate who will be thereby reminded of the picture that the patient is seeing on the patient's touch screen display. The PCA speaks into a microphone so as to be heard by the patient. The touch screen display for the patient is proximal a microphone to pickup the patient's voice so that the patient may converse with the Patient Care Advocate. A dialog box provides a user interface, as shown in FIG. 33, for the PCA to control the volume heard from the patient's room as well as a button to terminate the audio-video recordation session with the patient. A start/stop toggle icon allows the PCA to start or stop the two-way real time AV communication with the hospital room assigned to the PCA, as seen in FIG. 33.

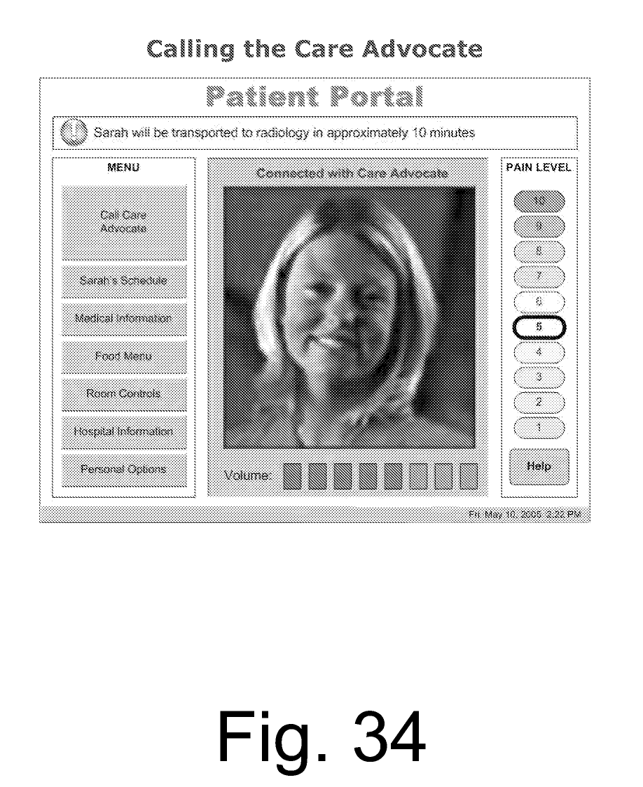

In use, the patient's call request alert comes up on the Patient Care Advocate's ‘dashboard’. The PCA then makes a ‘call’ into the patient. The PCA sees, in the lower right hand corner of the PCA's dashboard, a video feed of what the patient sees. Of course, anyone in the patient's room can activate the patient's PCA call button and then be seen by the PCA. For instance, the patient's physician in the patient's room can call the Patient Care Advocate to enter and/or receive dictation of new orders for the patient. FIG. 34, labeled ‘Patient Portal’, shows an exemplary view of what view might be seen on the touch screen display by viewers in the patient's room.

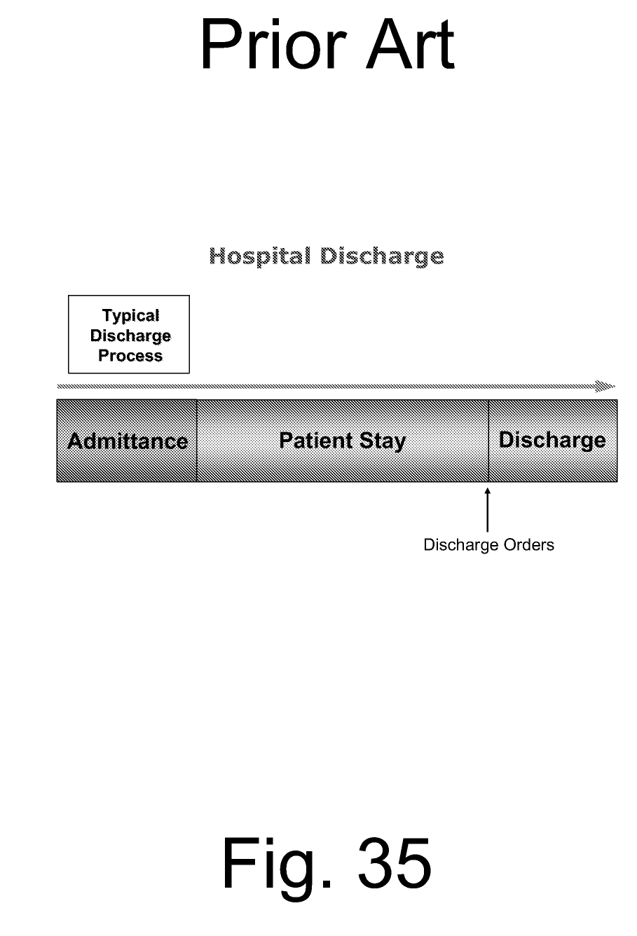

FIG. 35 shows a typical prior art time line illustrating an inefficient process of discharging a patient from the hospital, thereby delaying the time that a patient's bed and/or room for the patient is freed for the next patient's use. Typical discharge processes start at the time an order for discharge is written, which creates an inherent lag time. By the time the discharge order is written, no services needed by the patient for discharge have begun. For instance, the patient may require one or more bottles of oxygen to be sent home with the patient. A walker may be needed by a patient who has had knee surgery, and other durable medical equipment can be required for use at the patient's home. The patient may need a ramp to be built at their home to get a wheelchair into the entrance of the home. In short, there may be services to be ordered and work to be done in order to have a proper and orderly discharge process for the patient. Often, however, the discharge process does not start until well after a discharge order is written, thereby causing a lag in time that could last more than one day.

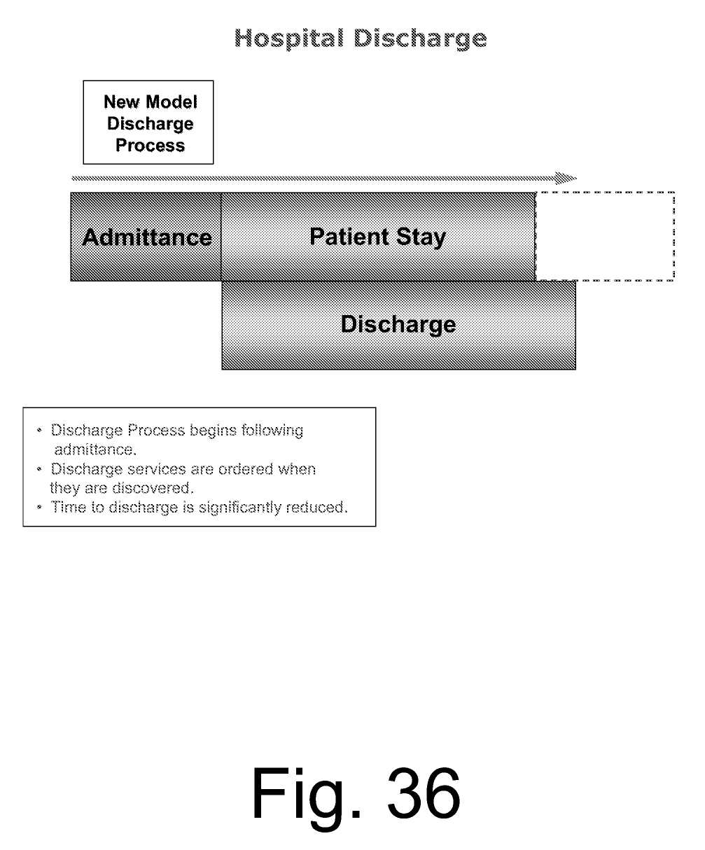

FIG. 36 shows an improvement of the prior art discharge process for implementations of the present invention in which the discharge order starts at the time when a patient arrives. As such, the patient's discharge is planned to begin following admittance of the patient to the hospital or in-patient healthcare facility. When services for the patient's healthcare treatment are ordered as they are discovered, the time required to discharge the patient can be significantly reduced. This proactive approach to starting the discharge process as early as is practical allows beds to be turned faster for use by other patients. This expediency can be extrapolated to make beds available faster to the sick and injured that arrive at a hospital's emergency room, thereby reducing the time in, and population of, those waiting in the emergency room. The PCA's dashboard allows the PCA to hear and see house keeping staff cleaning and preparing a bed for use after a patient has been discharged from a bed, thereby providing hospital management with an audio-visual monitor for the bed's availability.

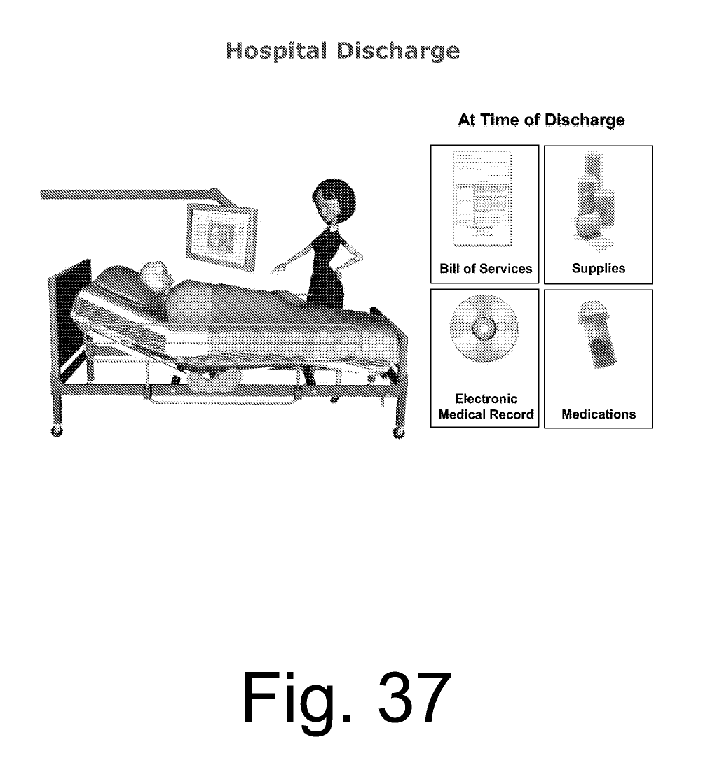

FIG. 37 shows, for the time of discharge, a bill that can be drawn up for the services rendered to a patient. The bill can be rendered by a business office that wishes to turn around a monetary bill for the services quicker. The patient can be given supplies prior to discharge that are needed for the time to be spent at home immediately following discharge. Medications can also be delivered to the patient at discharge for the patient's use at home, thereby obviating the need to go to a pharmacy to get supplies, prescriptions, or over-the-counter medications after discharge and before convalescing at the patient's home. An electronic medical record for the patient's in-patient stay at the healthcare facility can be stored on an optical disk, or other storage medium, and delivered at discharge to the patient. The disk can be given by the patient to a physician who can see what happened, what was given, and what procedures were performed during the patient's stay at the healthcare facility.

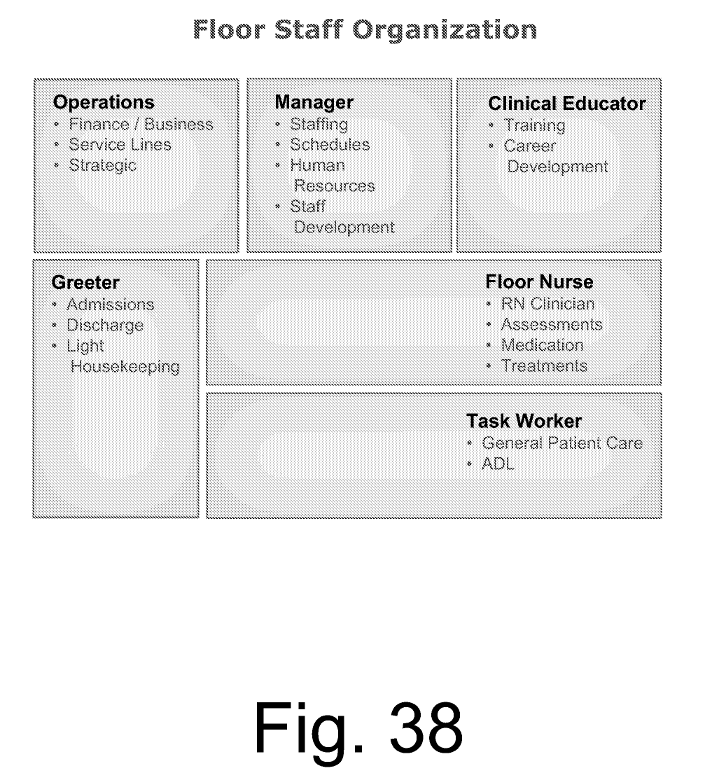

FIG. 38 is a block level diagram showing a floor staff organization in which one (1) person oversees a limited number of discrete responsibilities. In this organization, one person can oversee operations to drive their assigned service lines, finance and business functions, and strategic initiatives. Similarly, a manager of a healthcare facility unit can be relieved of all the ‘day-in and day-out’ staffing, thereby freeing them to look to a human resources department for recruitment, retention, and staff development. The unit manager can then focus upon the ‘day-in and day-out’ functions of the unit, rather than being side tracked into activities over which they have little or no control or no assigned responsibility. For instance, a clinical educator's responsibilities can be properly limited to training and career development of the staff of a particular area or unit.

Through electronic data management, the organization seen in FIG. 38 does not need a conventional unit clerk. A unit clerk was typically used to enter physicians' orders, order radiology services, order lab work for a patient, and otherwise basically enter data that effectively drove the schedule of tasks and workflow of healthcare services that were to be provided to a patient during a hospital stay. In the inventive workflow, a unit clerk is not needed. Instead, a person who is a ‘greeter’ has been added. As shown in FIG. 38, the greeter is responsible for various functions previously undertaken by skilled healthcare workers, including admission of patients, discharge of patients, and light housekeeping. As such, the greeter need not have a high level of healthcare training. In practice, the greeter meets patients and their families as they came onto a unit. The greeter can also be actively involved in the patient's care from the time of admission, such as by preparing the patient for discharge to go home, and helping to coordinate various functions and activities needed to discharge the patient. The greeter can keep the patient's room neat, clean and tidy, ensure that a housekeeping service has made scheduled visits to the patient's room for services such as renewing a supply of towels, and other administrative duties that make the patient's stay comfortable.

FIG. 38 also shows the function of a task worker in a floor staff organization. The task worker can help to deliver direct care to a patient that is important for the patient's activities of daily living, such as baths, use of the restroom, making the patient's bed, and light house keeping of the patient's room. Like the greeter, the task worker need not be extensively educated as would a nurse, physician, or physician's assistant. Rather, in the floor staff organization, only the floor nurse needs to be highly trained in medial science. As such, there will be less floor nurses in the inventive floor staff organization who are tasked with less non-medically intense tasks which are taken over by less educated workers.

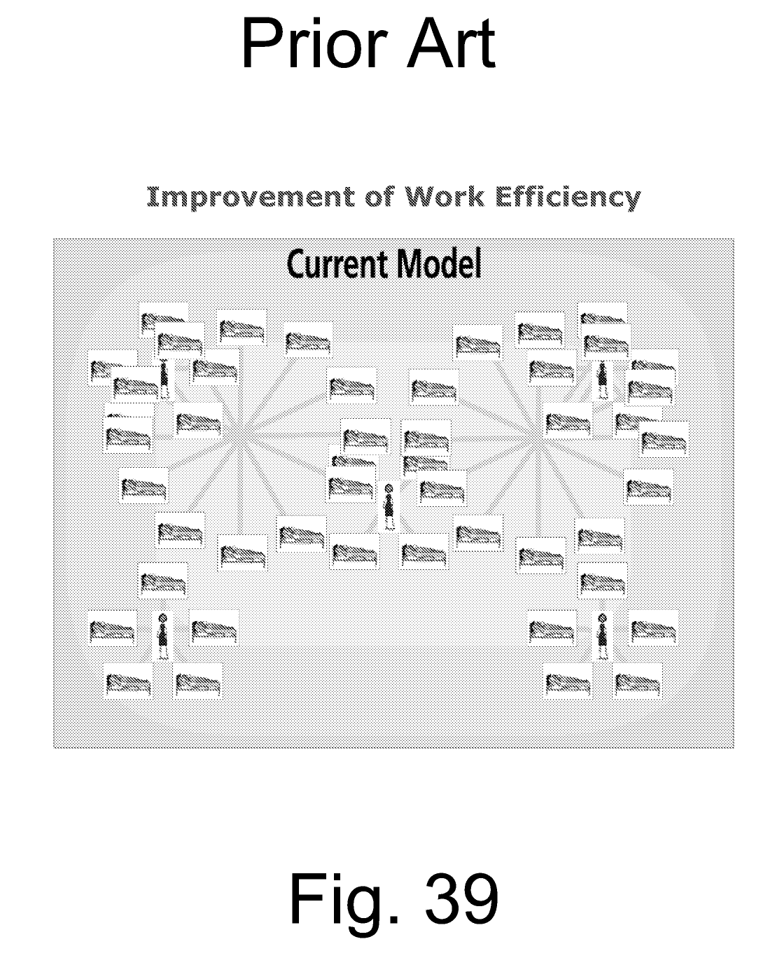

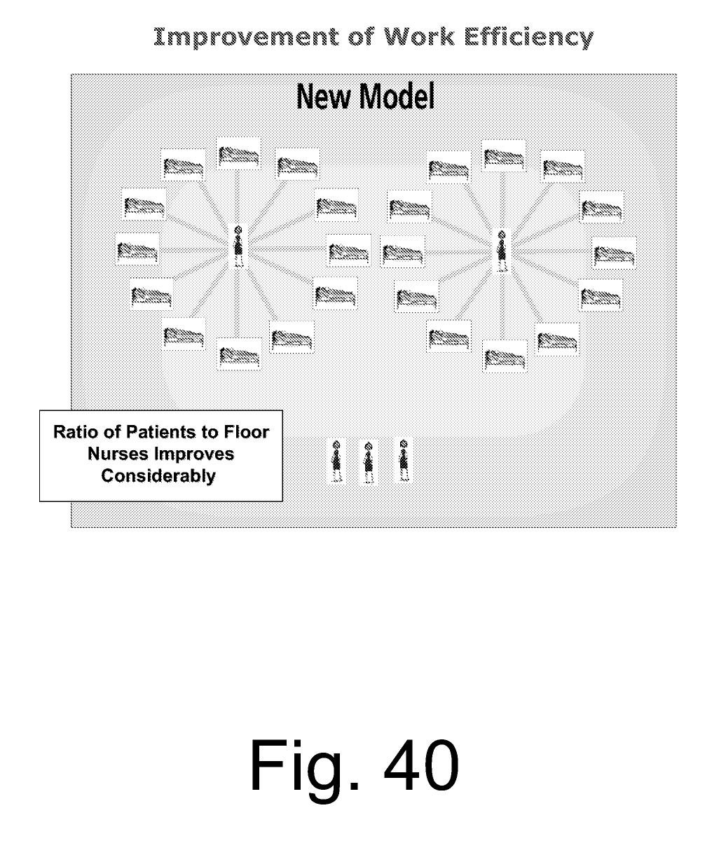

FIGS. 39 and 40 graphically depict the prior art and inventive floor staff organizations, respectively. FIG. 39 shows a floor nurse having many responsibilities to many centers of control. In contrast, FIG. 40 shows improvements in the work efficiency of a floor nurse by limiting the responsibility of the floor nurse to tasks ordinarily performed by medically trained personnel. Due to improvement of work efficiency in the inventive floor staff organization, the ratio of patients to floor nurses can be increased. Stated otherwise, there will be an assignment of more patients to a floor nurse who will be doing less non-medical tasks, thereby increasing the attention of the floor nurse to patient's for which the floor nurse is directly responsible.

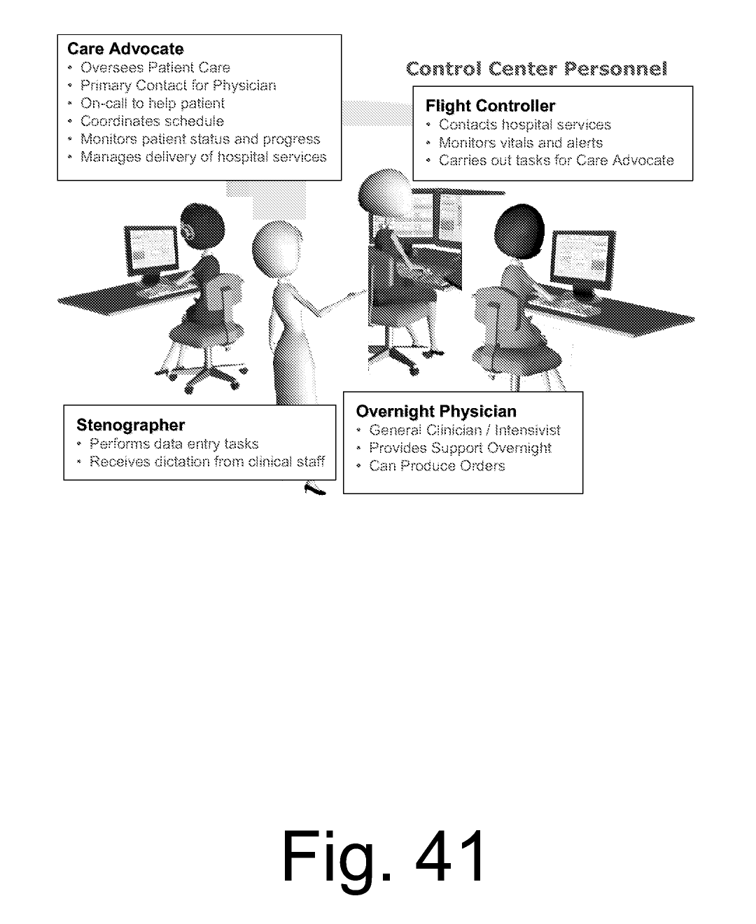

FIG. 41 provides an overview of personnel that are assigned to a control center of an in-patient a healthcare facility. The personnel can include a Patient Care Advocate (PCA), a Flight Controller, a stenographer, and an Overnight Physician. The PCA, discussed above, will preferably sit proximal the Flight Controller who assists the Patient Care Advocate. The Flight Controller can assist the PCA by undertaking tasks such as contacting various units in a hospital for services to be provided to a patient, assisting the PCA in the monitoring of vital signs and alerts for several patients, and undertake other tasks that are requested by the PCA.

The stenographer, discussed above, performs data entry tasks and receives dictation from clinical staff, assumes responsibility for transcribing dictation, and sending transcribed dictation to the appropriate person to validate the transcription. The Overnight Physician, who can be a general clinician and/or an intensivist, provides support to patients and staff overnight. One important function for the Overnight Physician is the production of orders in a timely manner for patients in the healthcare facility.

Prior art healthcare facility organizations adopted an inefficient procedure when there was an acute change in a patient's physical condition. In this circumstance hospital staff, typically a floor nurse, would undertake the task of locating the patient's physicians (e.g.; electronically paging the patient's physician) who was generally off site, and then waiting for a return contact from the patient's physicians. Once the patient's physician had been contacted, the physician would then take over the responsibility of monitoring the patient's condition for changes and, if necessary, writing an order for a needed medication or a needed procedure. In contrast, the inventive control center of an in-patient healthcare facility uses an Overnight Physician to avoid these requirements, where practical.

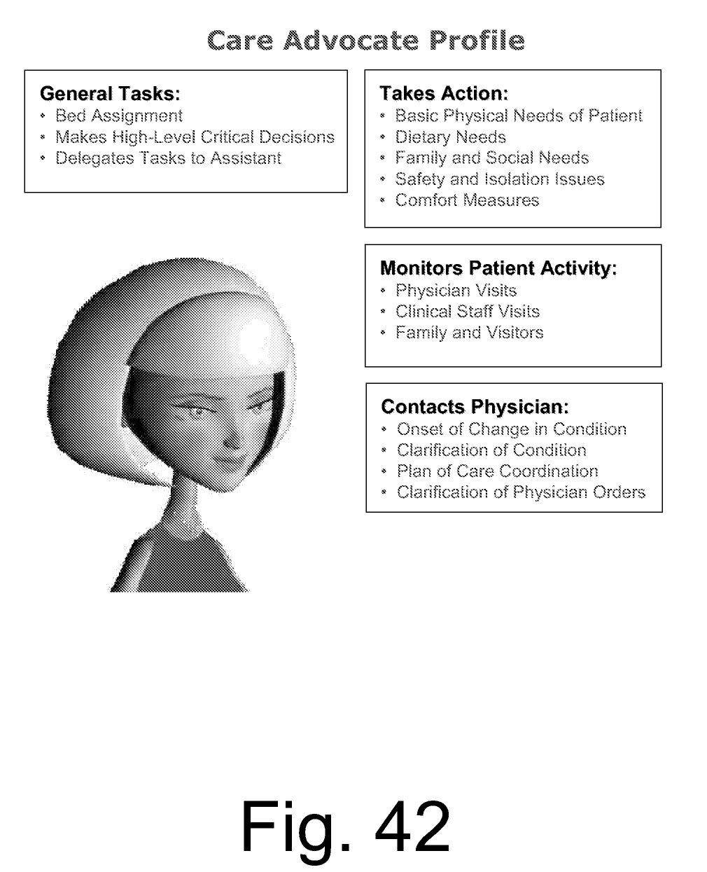

FIG. 42 shows categories of responsibilities assigned to the Patient Care Advocate, including general tasks, actions, monitoring, and contact responsibilities. Under general tasks, the PCA makes bed assignments, makes high-level critical decisions, and delegates tasks to an assistant (e.g.; the ‘Flight Controller’). The actions that the PCA takes are generally for the basic physical needs of the patients. Such general needs include remotely activating a thermostat for a patient's room so as to increase temperature or lower the temperature of the patient's room, helping with dietary needs, having conversations with the family of the patient, attending to the patient's social needs, ensuring safety and infectious disease issues are properly considered when a patient is to be kept in an isolation room, and other measures for the safety and comfort of the patients of the healthcare facility. The PCA monitors the room of the patient, such as when physicians, clinical staff, family, and/or visitors are present in the patient's room. The PCA can contact a patient's physician when the PCA observes monitors for the patient that indicate the onset of or a change in the patient's physical condition. Clarifications of the patient's condition or physician orders for the patient, and plan of care coordination for the patient can all be responsibilities that are assumed by the PCA.

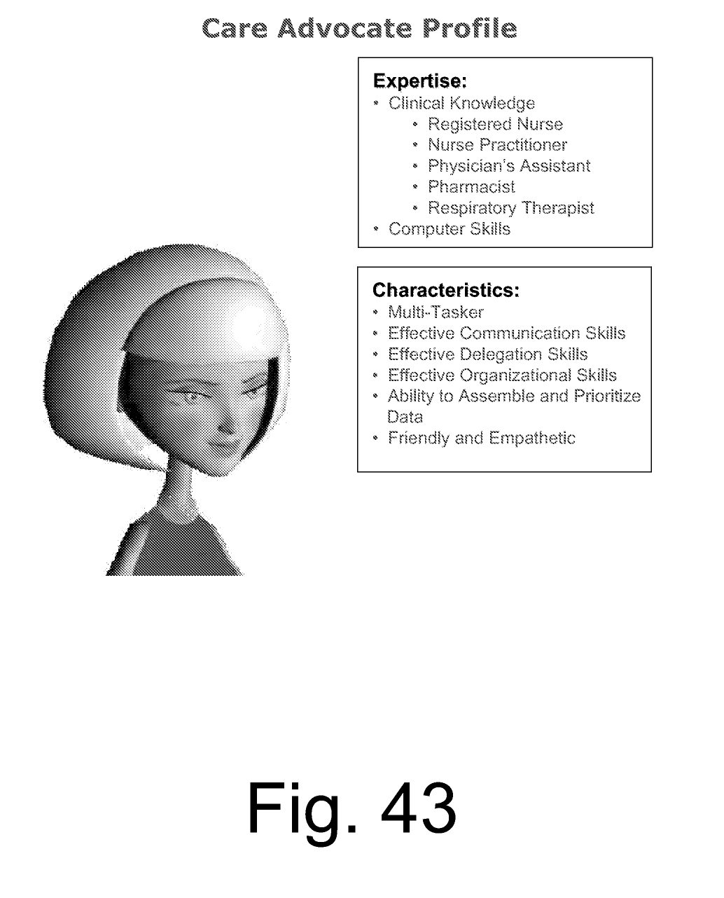

As shown in FIG. 43, the PCA's medical qualifications should be that of an expert in clinical knowledge. Stated otherwise, the PCA should have a clinical base with a basic anatomy/physiology background that enables them to make sound clinical decisions and interpret clinical data. Depending upon the type of healthcare facility, a PCA might be a registered nurse, a nurse practitioner, a physician's assistant, a pharmacist, a respiratory therapist, or a physician. Other than medical skills, the PCA should be a multitasker with effective communication skills, effective delegation skills, organizational skills, and the ability to assemble and prioritize data. A friendly and empathetic PCA is also desirable as the PCA will see and be seen by the patients.

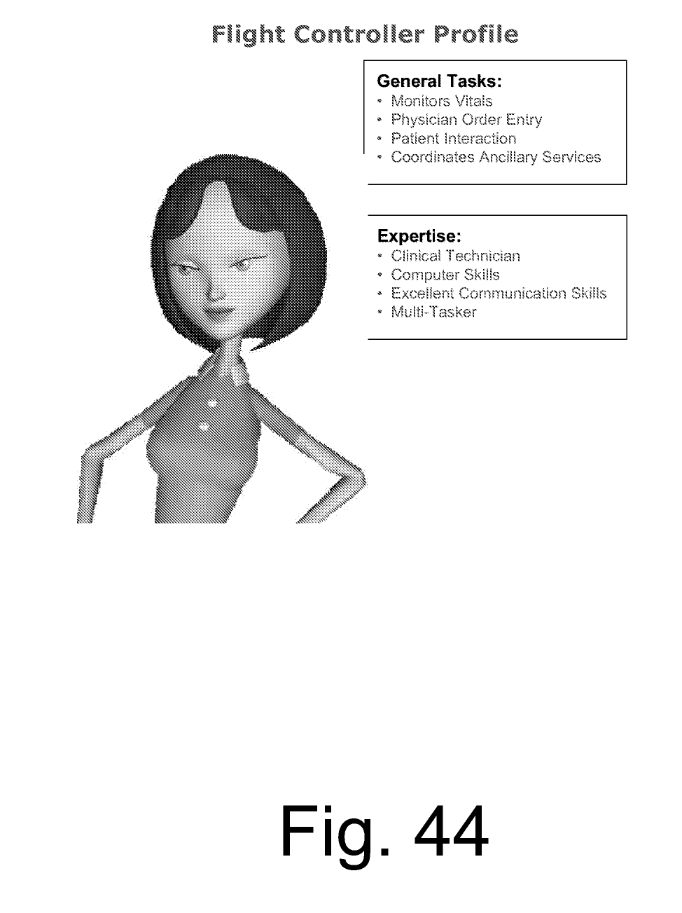

As shown in FIG. 44, the Flight Controller's medical qualifications are not as demanding as that of the PCA's. Rather, the Flight Controller's responsibilities might be to monitor vital signs of a plurality of patients, facilitate data entry for a physicians' orders, audio visually interact with patients, and coordinate ancillary services. Again, the Flight Controller's principle role is to be an assistant to the Patient Care Advocate. Preferably, however, a healthcare facility might require that its Flight Controllers be expert clinical technicians how have both computer and communication skills, while also being an adept multitasker.

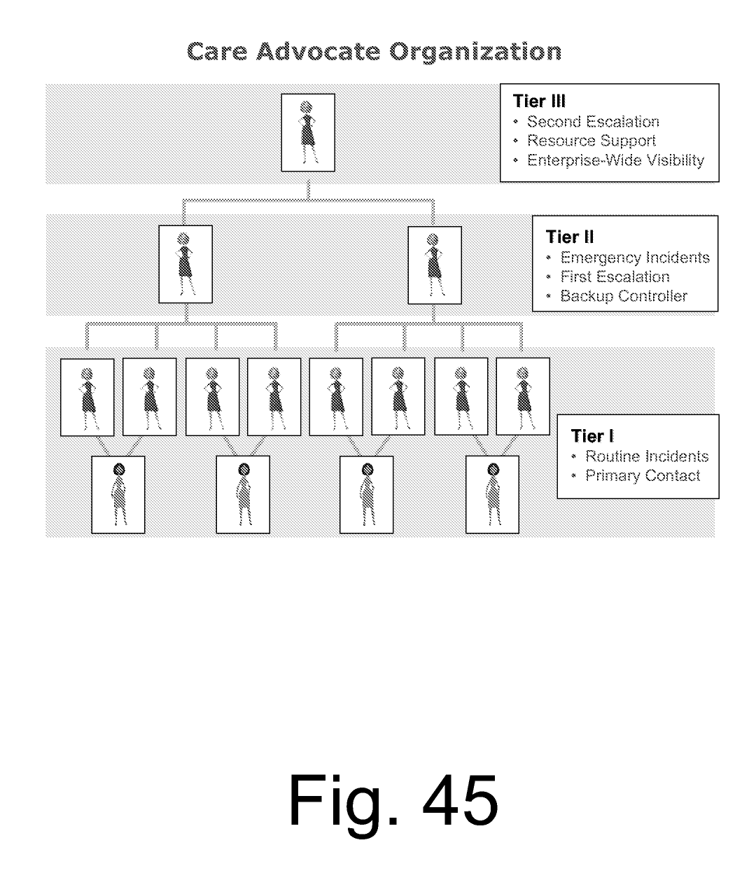

FIG. 45 shows an exemplary implementation for organization of the Patient Care Advocate role and function. At Tier 1 of the organization, the PCA handles routine incidents involving a patient, and serves as primary contact with the patient. As such, many PCAs are involved to accomplished these many and varied tasks for many patients.

At Tier II, a fewer number of PCAs are required. The PCA of Tier II is a manager of emergency incidents that require a first level of escalation in priority. The PCA of Tier II also serves as a backup to the over all controller PCA at Tier III. The overall controller PCA at Tier III is the manager of emergency incidents that require a second level of escalation in priority. The PCA of Tier III also in responsible for ensuring that there are adequate resources to support and monitor all patients that the Tier III PCA is responsible for. As such, the overall controller PCA at Tier III has enterprise wide visibility and control for one or more healthcare facilities.

The use of organizational Tiers I through III are provided to give the Patient Care Advocates at each level broad responsibility and to provide for the timely accomplishments of needed patient care if something happens acutely with any particular patient. In some implementations, there will be one Flight Controller for every two Patient Care Advocates, such that the Flight Controllers will be monitoring more patient vital signs than the Patient Care Advocates, in addition to artificial intelligence routines that are operated by computers for monitoring patient vital signs and alerting PCA's to critical conditions.

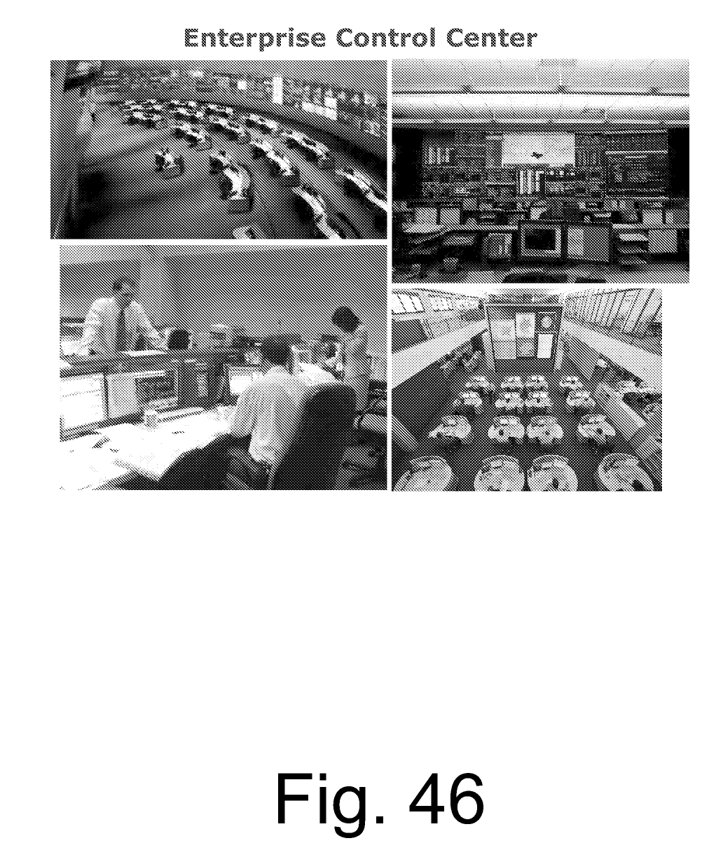

FIG. 46 depicts four (4) different environments that might be suitable for respective implementations of an Enterprise Control Center operated by PCAs and Flight Controllers for the benefit of one or more healthcare facilities which are remote one from another. By way of example, an Enterprise Control Center can operate numerous healthcare facilities, although the location of the Enterprise Control Center will not be located relatively near any of the healthcare facilities.

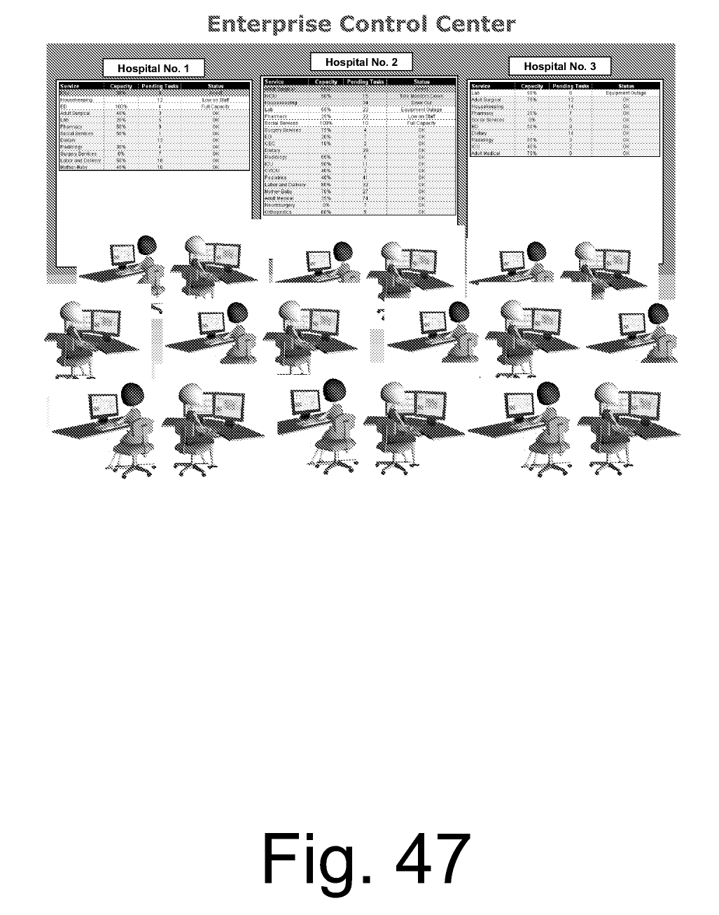

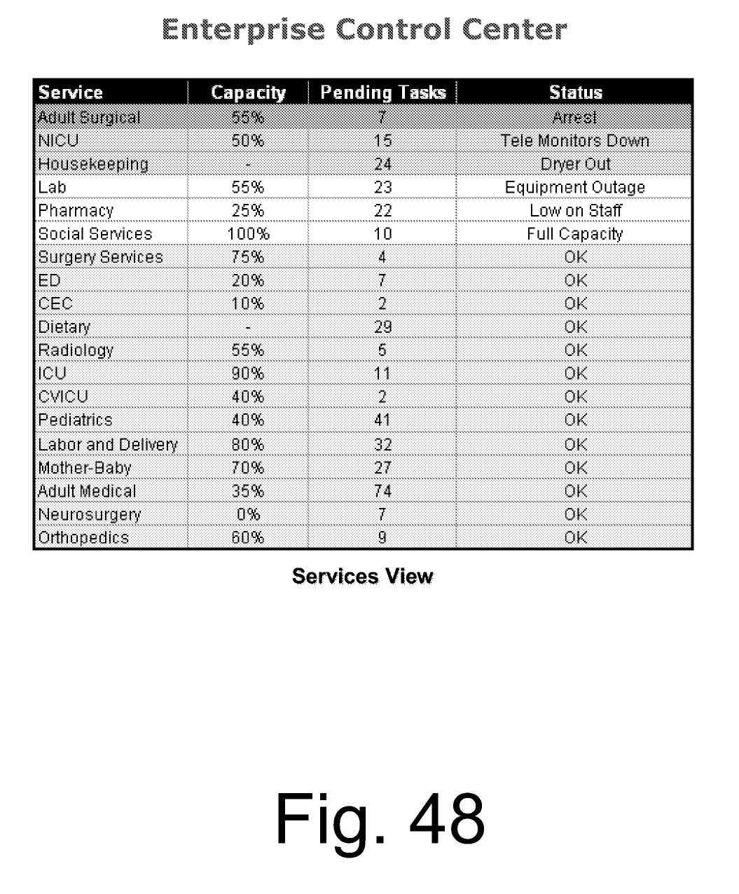

FIG. 47 shows, for three (3) different healthcare facilities, an overall view, called an “Enterprise Control Center” view, is given of the relative capacity of each unit in a healthcare facility. From this Enterprise Control Center view, a portion of which is seen larger in FIG. 48, a PCA can see whether a unit is too busy or has surplus availability to treat patients. The PCA can use this information to route a patient care tasks to or from a unit at a healthcare facility. If PCA sees that a unit has a bed available, the availability of the bed can be advertised to physicians in a local health care community who may have a patient in need of treatment by the unit.

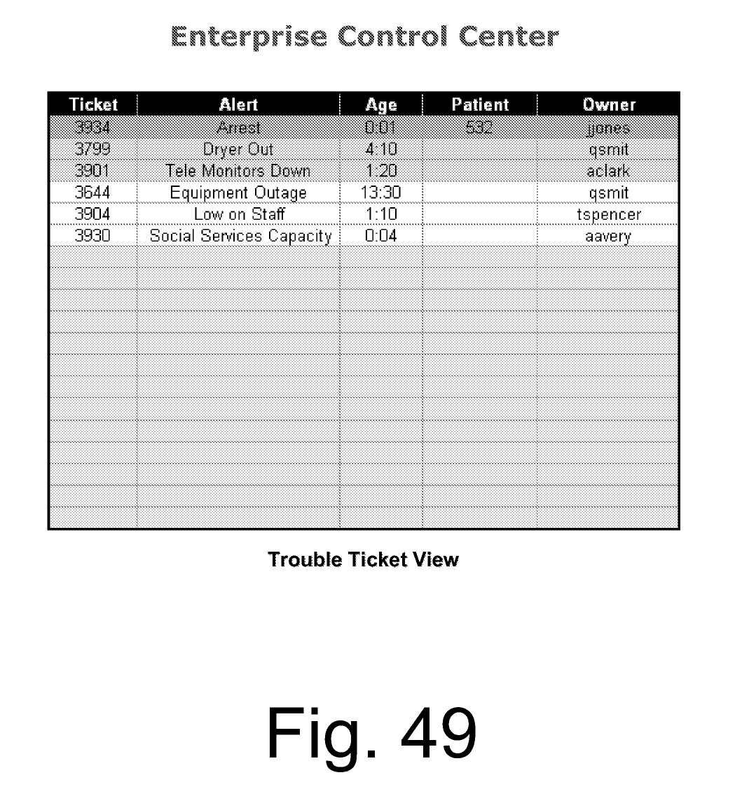

FIG. 49 shows various alerts about the operation of a healthcare facility that can be displayed upon a screen so as to be visible to PCAs and Flight Controllers. In particular, FIG. 49 shows the Enterprise Control Center status as to ongoing problems (e.g.; a ‘trouble ticket view’) and the reason why each trouble has occurred. This view is beneficial for a floor nurse who would otherwise be responsible for managing a troubled situation.

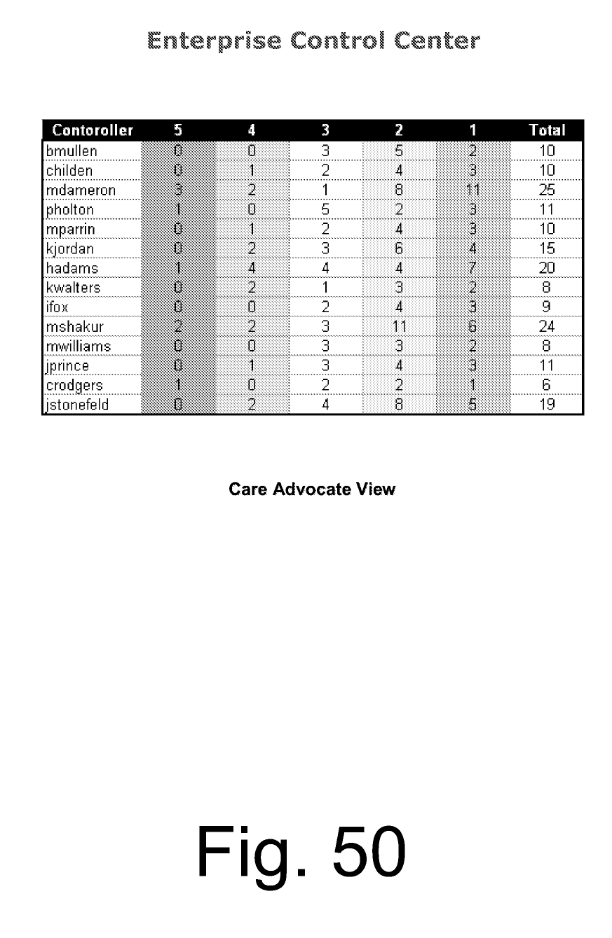

FIG. 50 shows the PCAs and Flight Controllers that are on duty and number of tasks and/or patients each has monitoring responsibility for at each of five (5) different priority levels. FIG. 50 shows, for each PCA, the severity level and number of tasks being monitored, to see if any PCA is being overwhelmed. For instance, for PCA B. Mullen shown in FIG. 50, no task have a high priority, 3 tasks have ‘yellow’ priorities, five (5) tasks are ‘green’, and two (2) tasks have the blue priority, with a total of ten (10) tasks. In contrast, the PCA mdameron has a much higher and number of tasks some of which have a high priority.

The displays seen in FIGS. 49-50 could be made available not just in an Enterprise Control Center view but also to an executive team of a healthcare facility or group of healthcare facilities so that information can be more effectively disseminated to decision makers who can more efficiently solve problems and remove barriers to the provision of effective healthcare.

For FIGS. 49-51, color codes can be used for different meanings, which will preferably be consistent throughout, regarding relative priority of tasks (not important vs. critical), percent of capacity at which a unit is currently functioning, warnings of not enough staff or beds, critical equipment that is not working, etc. For instance, in FIG. 49, the ticket number 3799 shows an orange colored alert which is the second to the highest alert, where it is shown that a dryer is out and has been out for 4 hours and 10 minutes. The hospital staff that owns the problem is also shown with the age of the problem. The ‘arrest’ warning, seen in red in FIG. 49, is the highest priority alert in that both immediate attention are needed as are many of the healthcare facility's resources, in order to resolve the alert.

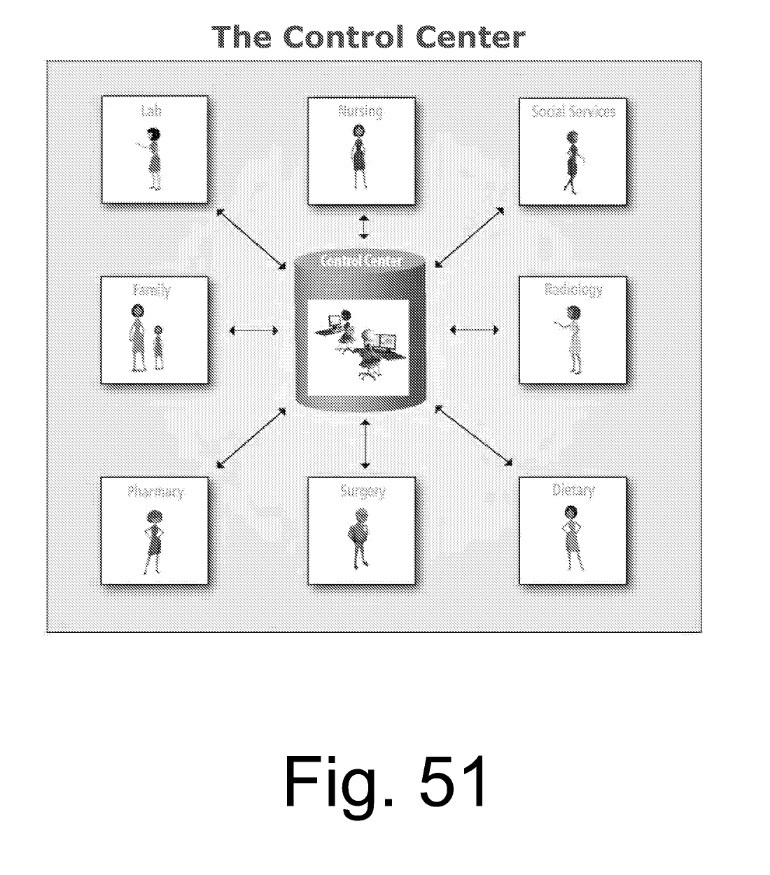

As shown in FIG. 51, the inventive Control Center removes from a floor nurse the duty to be the facilitator of communication to the patient which would otherwise be needed when healthcare services are not properly being delivered in the operation of prior art healthcare facilities. Rather, the unit and the provider of the service are held accountable, with visibility made available to both the floor nurse and healthcare facility management.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An in-patient hospital room having a hospital bed for a hospital patient, comprising:
means for receiving each of a plurality of views of the in-patient hospital room in real time audio-visual (AV) media;
means for communicating each of the plurality of views to a communicant outside of the in-patient hospital room; and
an in-room user interface (UI) including:
means for receiving and rendering real time AV media communication with the communicant; and
means for requesting the initiation said communication with the communicant outside of the in-patient hospital room.

2. The in-patient hospital room as defined in claim 1, further comprising means for monitoring a vital sign of the hospital patient, wherein the in-room UI further comprises:
means for receiving and rendering a representation of at least the next scheduled healthcare service to be provided to the hospital patient from a predetermined number thereof;
means for rendering, and placing a food order from, a food menu of food selections; and
means for requesting, receiving, and rendering pre-recorded audio and/or AV media.

3. The in-patient hospital room as defined in claim 1, wherein the means for receiving each of the plurality of views is remotely adjustable.

4. The in-patient hospital room as defined in claim 3, wherein the means for receiving is remotely adjustable by the communicant.

5. The in-patient hospital room as defined in claim 1, wherein the real time AV media communication with the communicant outside of the in-patient hospital room is a two-way communication between the communicant and the patient.

6. The in-patient hospital room as defined in claim 1, wherein the real time AV media communication with the communicant outside of the in-patient hospital room is a two-way communication between the communicant and a healthcare provider inside the in-patient hospital room.

7. The in-patient hospital room as defined in claim 1, wherein the requesting means is operable by the patient.

8. The in-patient hospital room as defined in claim 1, wherein the in-room UI further comprises means for receiving a subjective pain level category for the patient.

9. The in-patient hospital room as defined in claim 8, wherein the communicating means further comprising means for communicating to the communicant the received subjective pain level category for the patient.

10. An in-patient hospital room having a hospital bed for a hospital patient and a system to monitor a vital sign of the hospital patient, the in-patient hospital room comprising:
a remotely adjustable audio-visual (AV) apparatus to capture real time motion for each of a plurality of views of the in-patient hospital room and to capture real time sound in the in-patient hospital room; and
an input and display device with related apparatus to:
receive real time AV media communication with the communicant outside of the in-patient hospital room;
receive a subjective hospital patient pain level category;
send each of the plurality of views with the subjective hospital patient pain level category to the communicant; and
receive input signifying a request for the initiation of the AV media communication with the communicant outside of the in-patient hospital room.

11. The in-patient hospital room as defined in claim 10, wherein the remotely adjustable AV apparatus means is remotely adjustable by the communicant.

12. The in-patient hospital room as defined in claim 10, wherein the real time AV media communication with the communicant outside of the in-patient hospital room is a two-way communication between the communicant and the patient.

13. The in-patient hospital room as defined in claim 10, wherein the real time AV media communication with the communicant outside of the in-patient hospital room is a two-way communication between the communicant and a healthcare provider inside the in-patient hospital room.

14. The in-patient hospital room as defined in claim 10, wherein the input and display device with related apparatus is operable by the patient to request for the initiation of the communication with the communicant outside of the in-patient hospital room.

15. The in-patient hospital room as defined in claim 10, wherein the input and display device with related apparatus also receive and display:
a representation of at least the next scheduled healthcare service to be provided to the hospital patient from a predetermined number thereof; and
display, and receive input signifying the placing of an order from, a menu of:
food selections; and
a render of pre-recorded audio and/or AV media.

16. A hospital patient monitoring work station comprising:
means for selectively receiving and rendering a plurality of real time AV feeds from a respective plurality of in-patient hospital rooms in a hospital, each said in-patient hospital room having a hospital patient in a hospital bed;
adjustment means, corresponding to each said in-patient hospital room, for the selective receiving and rendering means to select any of a plurality of views of the in-patient hospital room for the real time AV feed thereof; and
means, corresponding to each said in-patient hospital room, for forming and directing real time AV media from a two-way communication with a communicant outside of the in-patient hospital room to a communicant inside the in-patient hospital room; and.

17. The hospital patient monitoring work station as defined in claim 16, wherein the selective receiving and rendering means renders on a display screen:
the selected said view of the in-patient hospital room;
the directed real time AV media from the two-way communication; and
an icon selectable to initiate or terminate the two-way communication between the respective communicants inside and outside the in-patient hospital room.

18. The hospital patient monitoring work station as defined in claim 16, further comprising means, corresponding to each said in-patient hospital room, for receiving a request for the two-way communication with the communicant outside of the in-patient hospital room via the real time AV feed.

19. The hospital patient monitoring work station as defined in claim 16, wherein the receiving means further comprises means for receiving a request for:
a food order; and
a pre-recorded audio and/or AV media rendering inside the in-patient hospital room.

20. The hospital patient monitoring work station as defined in claim 16, wherein the receiving means further comprises means for receiving and rendering at least one of:
monitored vital signs of the patient in the hospital bed;
a subjective pain level category of the hospital patient; and
at least the next scheduled healthcare service to be provided to the hospital patient from a predetermined number thereof.

21. The hospital patient monitoring work station as defined in claim 16, wherein the adjustment means is remotely adjustable by the communicant.

22. The hospital patient monitoring work station as defined in claim 16, wherein the communicant outside of the in-patient hospital room is an operator of the hospital patient monitoring work station and the communicant inside the in-patient hospital room is at least one of the patient and a healthcare provider for the patient.

23. The hospital patient monitoring work station as defined in claim 18, wherein the means for receiving the request is operable by the patient.

24. A hospital patient monitoring work station for a plurality of in-patient hospital rooms in a hospital, the work station comprising an input and rendering device with related apparatus to selectively:
direct real time audio-visual (AV) media from a two-way communication with a communicant outside of a selected said in-patient hospital room to a communicant inside the selected said in-patient hospital room;
adjust, receive, and render each of a plurality of views of a selected said in-patient hospital room from a respective remotely adjustable AV apparatus that each capture for the selected said in-patient hospital room:
real time motion in each said view; and
real time sound;
receive and render for a selected said in-patient hospital room a request for the two-way communication with the communicant outside of the in-patient hospital room via the real time AV feed.

25. The hospital patient monitoring work station as defined in claim 24, wherein the input and rendering device with related apparatus renders on a display screen:
the selected said view of the in-patient hospital room;
the directed real time AV media from the two-way communication; and
an icon selectable to initiate or terminate the two-way communication between the respective communicants inside and outside the in-patient hospital room.

26. The hospital patient monitoring work station as defined in claim 24, wherein the selective adjustment for the plurality of views is made by the communicant outside of the in-patient hospital room.

27. The hospital patient monitoring work station as defined in claim 24, wherein the communicant outside of the in-patient hospital room is an operator of the hospital patient monitoring work station and the communicant inside the in-patient hospital room is at least one of the patient and a healthcare provider for the patient.

28. The hospital patient monitoring work station as defined in claim 24, wherein the request for the two-way communication with the communicant outside of the in-patient hospital room via the real time AV feed is received in a communication from the communicant inside the selected said in-patient hospital room.

29. The hospital patient monitoring work station as defined in claim 24, wherein the input and rendering device with related apparatus selectively receives and renders for the selected said in-patient hospital room:
a monitored vital sign of the patient in the hospital bed;
a subjective pain level category of a hospital patient in the in-patient hospital room;
at least the next scheduled healthcare service to be provided to the hospital patient from a predetermined number thereof; and
a request for:
a food order; and
a pre-recorded audio and/or AV media rendering inside the in-patient hospital room.

30. A hospital comprising:
a plurality of in-patient hospital rooms each having:
a hospital bed for a hospital patient;
remotely adjustable means for receiving each of a plurality of views of the in-patient hospital room in real time audio-visual (AV) media;
means for communicating each of the plurality of views to a communicant outside of the in-patient hospital room; and
an in-room user interface (UI) including means for requesting, receiving and rendering real time AV communication of the communicant outside of the in-patient hospital room.
a hospital patient monitoring work station including:
means, corresponding to the remotely adjustable means of each said in-patient hospital room, for selectively receiving and rendering each of the plurality of views of the in-patient hospital room in the real time AV feed;
means, corresponding to each said in-patient hospital room, for forming and directing the real time AV media from the communication with the communicant outside of the in-patient hospital room to a selected said in-patient hospital room; and
means, corresponding to each said in-patient hospital room, for receiving the request from the patient for the communication with the communicant via the real time AV feed;
means for facilitating communication between the hospital patient monitoring work station and each said in-patient hospital room.

31. The hospital as defined in claim 30, wherein the in-room UI further comprises:
means for receiving and rendering a representation of at least the next scheduled healthcare service to be provided to the hospital patient from a predetermined number thereof;
means for receiving a patient input subjective pain level; and
means for rendering, and placing an order from, a menu of:
food selections; and
pre-recorded audio and/or AV media.

32. The hospital as defined in claim 31, wherein the hospital patient monitoring work station further comprises means, corresponding to each said in-patient hospital room, for receiving and rendering:
the patient input subjective pain level;
monitored vital signs for the patient from one or more vital sign monitoring systems;
the representation of at least the next scheduled healthcare service to be provided to the patient from the predetermined number of scheduled healthcare services to be provided within the hospital to the patient;
the food order; and
the pre-recorded audio and/or AV media order.

33. The hospital as defined in claim 30, wherein the remotely adjustable means for receiving each of the plurality of views of the in-patient hospital room in real time AV media is selectively adjustable by the communicant outside of the in-patient hospital room.

34. The hospital as defined in claim 30, wherein the communicant outside of the in-patient hospital room is an operator of the hospital patient monitoring work station and the communicant inside the in-patient hospital room is at least one of the patient and a healthcare provider for the patient.

35. The hospital as defined in claim 30, wherein the request for the communication with the communicant outside of the in-patient hospital room via the real time AV media is received in a communication from the communicant inside the selected said in-patient hospital room.

36. The hospital as defined in claim 30, wherein the selective receiving and rendering means renders on a display screen:
the selected said view of the in-patient hospital room;
the directed real time AV media from the two-way communication; and
an icon selectable to initiate or terminate the two-way communication between the respective communicants inside and outside the in-patient hospital room.

37. A hospital comprising:
a plurality of in-patient hospital rooms each having:
a hospital bed for a hospital patient;
a remotely adjustable audio-visual (AV) apparatus to capture real time motion for each of a plurality of views of the in-patient hospital room and to capture real time sound in the in-patient hospital room; and
an input and display device with related apparatus to:
receive input signifying a request for the initiation of a real time AV communication with a communicant outside of the in-patient hospital room; and
receive and display real time AV media from the communication with the communicant outside of the in-patient hospital room;
a hospital patient monitoring work station including an input and rendering device with related apparatus to selectively:
direct real time audio-visual (AV) media from the two-way communication with a selected said communicant outside of a selected said in-patient hospital room to a communicant inside a selected said in-patient hospital room;
adjust, receive, and render each of the plurality of views of each of the plurality of in-patient hospital rooms from the respective plurality of the remotely adjustable AV apparatus; and
receive and render for each said in-patient hospital room the request for the initiation of the real time AV communication with the communicant outside of the in-patient hospital room;
a network facilitating communication between the hospital patient monitoring work station and each said in-patient hospital room.

38. The hospital as defined in claim 37, wherein for each said in-patient hospital room, each said input and display device with related apparatus receives and displays:
a subjective hospital patient pain level category;
a representation of at least the next scheduled healthcare service to be provided to the hospital patient from a predetermined number thereof; and
input signifying the placing of an order from, a menu of:
food selections; and
renderings of pre-recorded audio and/or AV media.

39. The hospital as defined in claim 38, the hospital patient monitoring work station receives and renders for each said in-patient hospital room:
a monitored vital sign of the patient in the hospital bed;
the subjective hospital patient pain level category;
the at least the next scheduled healthcare service to be provided to the hospital patient from a predetermined number thereof; and
the ordered food selections; and
the ordered pre-recorded audio and/or AV media renderings.

40. The hospital as defined in claim 37, wherein the adjustment of the plurality of views of each of the plurality of in-patient hospital rooms is selectively adjustable by the communicant outside of the in-patient hospital room.

41. The hospital as defined in claim 37, wherein the communicant outside of the in-patient hospital room is an operator of the hospital patient monitoring work station and the communicant inside the in-patient hospital room is at least one of the patient and a healthcare provider for the patient.

42. The hospital as defined in claim 30, wherein the received input signifying the request for the initiation of the real time AV communication with the communicant outside of the in-patient hospital room is received in a communication from the communicant inside the selected said in-patient hospital room.

43. The hospital as defined in claim 37, wherein the input and rendering device with related apparatus renders on a display screen:
the selected said view of the in-patient hospital room;
the directed real time AV media from the two-way communication; and
an icon selectable to initiate or terminate the two-way communication between the respective communicants inside and outside the in-patient hospital room.

44. A system for monitoring patient well being in a plurality of hospitals each having a plurality of hospital rooms, each hospital room having a hospital bed for a patient, the system comprising:
means, corresponding to each said hospital room, for:
receiving input from the patient requesting a two-way AV communication with an assigned patient care advocate; and
rendering the requested AV communication with the assigned patient care advocate;
a plurality of a hospital patient monitoring work stations each being operated by one said patient care advocate, each said patient care advocate being assigned to a plurality of said patients, each said work station comprising an input and rendering device with related apparatus to selectively:
receive, from the patients assigned to the patient care advocate, the request for the two-way AV communication; and
direct, in response to a selected said request received from an assigned said patient, the requested two-way AV communication from between the patient and the patient care advocate for rendering by the corresponding said receiving and rendering means.

45. The system for monitoring healthcare facilities as defined in claim 44, wherein each said hospital patient monitoring work station further comprises means, corresponding to each said two-way AV communication between the patient care advocate and the assigned patient, for rendering:
real time AV media of the patient care advocate being captured by the input and rendering device with related apparatus;
real time AV media of the assigned patient being captured by the corresponding said AV input device; means for selectively initiating and terminating the two-way communication between the patient and the patient care advocate.
